(19) United States
(12) Patent Application Publication
(10) Pub. No.: US 2021/0116941 A1
(43) Pub. Date: Apr. 22, 2021

(54) POSITIONING METHOD USING UNMANNED AERIAL ROBOT AND DEVICE FOR SUPPORTING SAME IN UNMANNED AERIAL SYSTEM

(71) Applicant: LG ELECTRONICS INC., Seoul (KR)

(72) Inventors: Sanghak LEE, Seoul (KR); Jeongkyo SEO, Seoul (KR); Beomseok CHAE, Seoul (KR); Hyunjai SHIM, Seoul (KR); Pilwon KWAK, Seoul (KR)

(73) Assignee: LG ELECTRONICS INC.

(21) Appl. No.: 16/843,223

(22) Filed: Apr. 8, 2020

(30) Foreign Application Priority Data
Oct. 22, 2019 (KR) 10-2019-0131682

(51) Int. Cl. G05D 1/10; G01S 17/894; G05D 1/00; G08G 5/00; B60L 53/12; B64C 39/02; B64D 47/08; B64D 27/24

(52) U.S. Cl. CPC G05D 1/101; G01S 17/894; G05D 1/0094; G08G 5/003; B60L 53/12; B64C 39/024; B64C 2201/108; B64D 27/24; G05D 1/0022; B60L 2200/10; B64C 2201/027; B64C 2201/042; B64D 47/08

(57) ABSTRACT

A flight system for indoor positioning includes an unmanned aerial robot, and a station and a server of the unmanned aerial robot. The unmanned aerial robot may sense a plurality of laser beams generated from the station through a first camera and/or a first sensor, perform adjustment such that a horizontal axis position of the unmanned aerial robot is located at a center position of a measurement space for the indoor positioning based on the plurality of sensed laser beams, and perform positioning in the measurement space while flying in a vertical direction.

### CROSS-REFERENCE TO RELATED APPLICATION

This application claims priority under 35 U.S.C. § 119 to Korean Application No. 10-2019-0131682 filed on Oct. 22, 2019, whose entire disclosure is hereby incorporated by reference.

### BACKGROUND

### 1. Field

The present disclosure relates to an unmanned aerial system and, more particularly, to an indoor positioning method using an unmanned aerial robot and a device for supporting the same.

### 2. Background

An unmanned aerial vehicle generally refers to an aircraft and a helicopter-shaped unmanned aerial vehicle/uninhabited aerial vehicle (UAV) capable of a flight and control by a radio wave guidance without a pilot. A recent unmanned aerial vehicle is increasingly used in various civilian and commercial fields, such as image photographing, unmanned delivery service, and disaster observation, in addition to military use such as reconnaissance and attack.

For example, positioning on a space where people are difficult to directly perform positioning (for example, a narrow space, a measurement space for elevator installation, and the like) may be performed using an unmanned aerial robot.

In this case, a user may control the unmanned aerial robot from the outside to perform positioning a space that is difficult for the user to directly perform positioning through a camera provided in the unmanned aerial robot.

### BRIEF DESCRIPTION OF THE DRAWINGS

The embodiments will be described in detail with reference to the following drawings in which like reference numerals refer to like elements wherein:

FIG. 1 shows a perspective view of an unmanned aerial vehicle to which a method proposed in this specification is applicable.

FIG. 2 is a block diagram showing a control relation between major elements of the unmanned aerial vehicle of FIG. 1.

FIG. 3 is a block diagram showing a control relation between major elements of an aerial control system according to an embodiment of the present disclosure.

FIG. 4 illustrates a block diagram of a wireless communication system to which methods proposed in this specification are applicable.

FIG. 5 is a diagram showing an example of a signal transmission/reception method in a wireless communication system.

FIG. 6 shows an example of a basic operation of a robot and a 5G network in a 5G communication system.

FIG. 7 illustrates an example of a basic operation between robots using 5G communication.

FIG. 8 is a diagram showing an example of the concept diagram of a 3GPP system including a UAS.

FIG. 9 shows examples of a C2 communication model for a UAV.

FIG. 10 is a flowchart showing an example of a measurement execution method to which the present disclosure is applicable.

FIG. 11 shows an example of a drone for positioning and a drone station according to an embodiment of the present disclosure.

FIG. 12 shows an example of main components of the drone for positioning according to the embodiment of the present disclosure.

FIG. 13 shows an example of main components of the station for vertical flight of the drone according to the embodiment of the present disclosure.

FIG. 14 is a flowchart showing an example of a positioning method using vertical flight according to the embodiment of the present disclosure.

FIGS. 15 and 16 show examples of a method for locating the station at the center position of a measurement space for vertical flight of an unmanned aerial robot according to the embodiment of the present disclosure.

FIGS. 17 and 18 show examples of a method for causing the unmanned aerial robot to fly vertically while maintaining a horizontal axis position by using the station according to the embodiment of the present disclosure.

FIG. 19 is a flowchart showing an example of a method for causing the unmanned aerial robot to fly vertically while maintaining a horizontal axis position by using the station according to the embodiment of the present disclosure.

FIG. 20 is a flowchart showing another example of the method for causing the unmanned aerial robot to fly vertically while maintaining a horizontal axis position by using the station according to the embodiment of the present disclosure.

FIG. 21 is a diagram showing an example of a positioning method according to the embodiment of the present disclosure.

FIG. 22 is a flowchart showing an example of the positioning method according to the embodiment of the present disclosure.

FIGS. 23 and 24 show examples of a lidar of the unmanned aerial robot according to the embodiment of the present disclosure.

FIG. 25 illustrates a block diagram of a wireless communication device according to an embodiment of the present disclosure.

FIG. 26 illustrates a block diagram of a communication device according to an embodiment of the present disclosure.

### DETAILED DESCRIPTION

Hereinafter, preferred embodiments according to the present disclosure are described in detail with reference to the accompanying drawings. The same reference numerals are assigned to the same or similar elements regardless of their reference numerals, and redundant descriptions thereof are omitted.

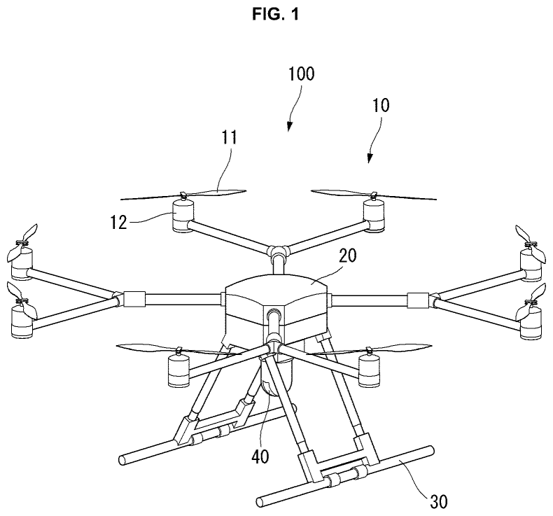

FIG. 1 shows a perspective view of an unmanned aerial vehicle according to an embodiment of the present disclosure. First, the unmanned aerial vehicle 100 is manually manipulated by an administrator on the ground, or it flies in an unmanned manner while it is automatically piloted by a configured flight program. The unmanned aerial vehicle 100, as in FIG. 1, includes a main body 20, a horizontal and vertical movement propulsion device 10, and landing legs 130. The main body 20 is a body portion on which a module, such as a task unit 40, is mounted.

The horizontal and vertical movement propulsion device 10 includes one or more propellers 11 positioned vertically to the main body 20. The horizontal and vertical movement propulsion device 10 according to an embodiment of the present disclosure includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12. The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

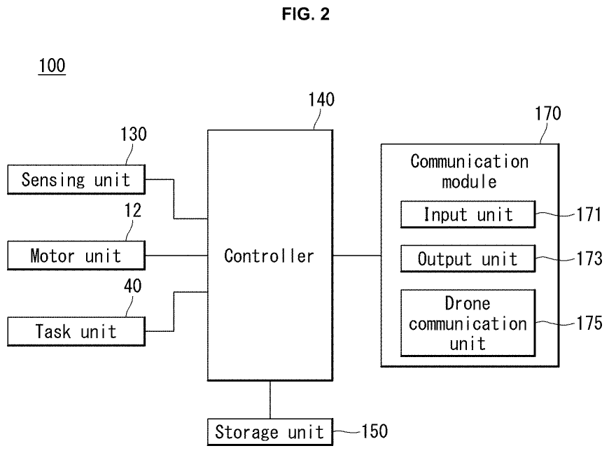

FIG. 2 is a block diagram showing a control relation between major elements of the unmanned aerial vehicle of FIG. 1. Referring to FIG. 2, the unmanned aerial vehicle 100 measures its own flight state using a variety of types of sensors in order to fly stably. The unmanned aerial vehicle 100 may include a sensing unit 130 including at least one sensor. The flight state of the unmanned aerial vehicle 100 is defined as rotational states and translational states. The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (ϕ). The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the present disclosure includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology. Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (ϕgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (ϕacc)” and “pitch (θacc).” The values are used to remove a bias error included in “roll (ϕgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value. The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a unmanned aerial robot communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300. For example, the unmanned aerial vehicle 100 may directly receive information from the input unit 171. For another example, the unmanned aerial vehicle 100 may receive information, input to a separate terminal 300 or server 200, through the unmanned aerial robot communication unit 175. For example, the unmanned aerial vehicle 100 may directly output information to the output unit 173. For another example, the unmanned aerial vehicle 100 may transmit information to a separate terminal 300 through the unmanned aerial robot communication unit 175 so that the terminal 300 outputs the information.

The unmanned aerial robot communication unit 175 may be provided to communicate with an external server 200, an external terminal 300, etc. The unmanned aerial robot communication unit 175 may receive information input from the terminal 300, such as a smartphone or a computer. The unmanned aerial robot communication unit 175 may transmit information to be transmitted to the terminal 300. The terminal 300 may output information received from the unmanned aerial robot communication unit 175.

The unmanned aerial robot communication unit 175 may receive various command signals from the terminal 300 or/and the server 200. The unmanned aerial robot communication unit 175 may receive area information for driving, a driving route, or a driving command from the terminal 300 or/and the server 200. In this case, the area information may include flight restriction area (A) information and approach restriction distance information.

The input unit 171 may receive On/Off or various commands. The input unit 171 may receive area information. The input unit 171 may receive object information. The input unit 171 may include various buttons or a touch pad or a microphone. The output unit 173 may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a controller 140 for processing and determining various pieces of information, such as mapping and/or a current location. The controller 140 may control an overall operation of the unmanned aerial vehicle 100 through control of various elements that configure the unmanned aerial vehicle 100.

The controller 140 may receive information from the communication module 170 and process the information. The controller 140 may receive information from the input unit 171, and may process the information. The controller 140 may receive information from the unmanned aerial robot communication unit 175, and may process the information.

The controller 140 may receive sensing information from the sensing unit 130, and may process the sensing information. The controller 140 may control the driving of the motor 12. The controller 140 may control the operation of the task unit 40.

The unmanned aerial vehicle 100 includes a storage unit 150 for storing various data. The storage unit 150 records various pieces of information necessary for control of the unmanned aerial vehicle 100, and may include a volatile or non-volatile recording medium. A map for a driving area may be stored in the storage unit 150. The map may have been input by the external terminal 300 capable of exchanging information with the unmanned aerial vehicle 100 through the unmanned aerial robot communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

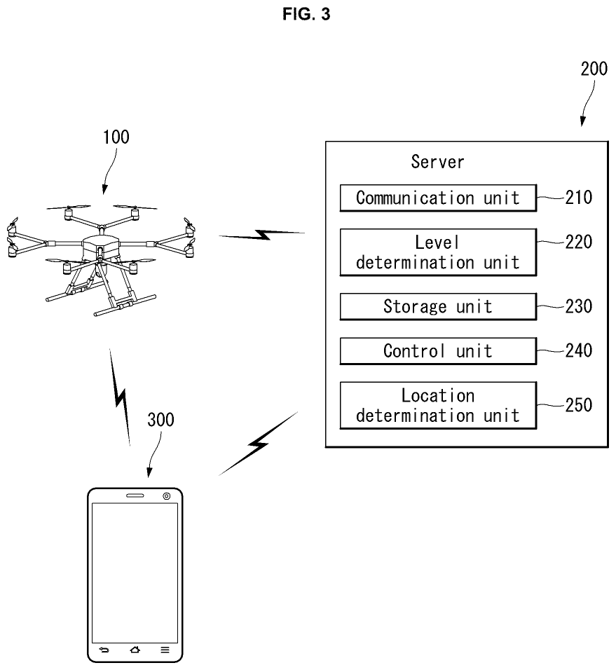

FIG. 3 is a block diagram showing a control relation between major elements of an aerial control system according to an embodiment of the present disclosure. Referring to FIG. 3, the aerial control system according to an embodiment of the present disclosure may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In this specification, a base station has a meaning as a terminal node of a network that directly performs communication with a terminal. In this specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station. Specific terms used in the following description have been provided to help understanding of the present disclosure. The use of such a specific term may be changed into another form without departing from the technical spirit of the present disclosure.

Embodiments of the present disclosure may be supported by standard documents disclosed in at least one of IEEE 802, 3GPP and 3GPP2, that is, radio access systems. That is, steps or portions not described in order not to clearly disclose the technical spirit of the present disclosure in the embodiments of the present disclosure may be supported by the documents. Furthermore, all terms disclosed in this document may be described by the standard documents. In order to clarity the description, 3GPP 5G is chiefly described, but the technical characteristic of the present disclosure is not limited thereto.

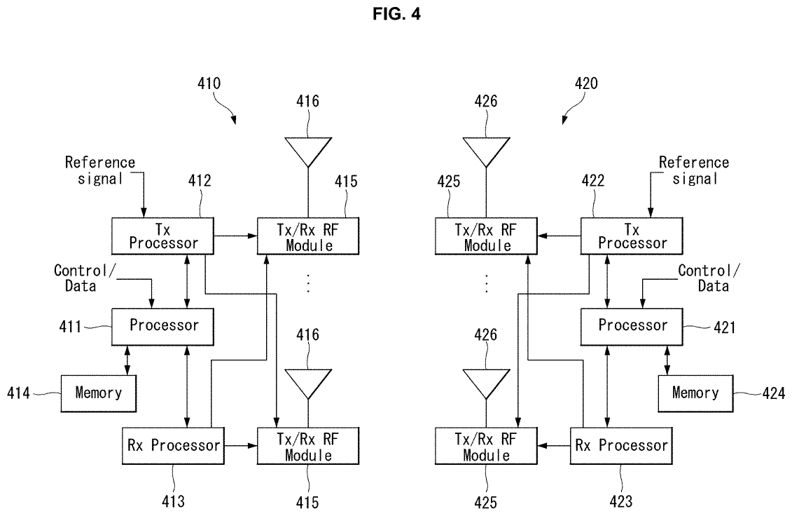

An aspect of the present disclosure will be described with respect to a UE and 5G network block diagram example. FIG. 4 illustrates a block diagram of a wireless communication system to which methods proposed in this specification are applicable. Referring to FIG. 4, an unmanned aerial robot is defined as a first communication device (910 of FIG. 4). A processor 911 may perform a detailed operation of the drone.

The unmanned aerial robot may be represented as an unmanned aerial vehicle or drone. A 5G network communicating with an unmanned aerial robot may be defined as a second communication device (920 of FIG. 4). A processor 921 may perform a detailed operation of the unmanned aerial robot. In this case, the 5G network may include another unmanned aerial robot communicating with the unmanned aerial robot.

A 5G network maybe represented as a first communication device, and a unmanned aerial robot may be represented as a second communication device. For example, the first communication device or the second communication device may be a base station, a network node, a transmission terminal, a reception terminal, a wireless apparatus, a wireless communication device or an unmanned aerial robot.

For example, a terminal or a user equipment (UE) may include an unmanned aerial robot, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 910, the second communication device 920 includes a processor 911, 921, a memory 914, 924, one or more Tx/Rx radio frequency (RF) modules 915, 925, a Tx processor 912, 922, an Rx processor 913, 923, and an antenna 916, 926. The Tx/Rx module is also called a transceiver. Each Tx/Rx module 915 transmits a signal each antenna 926. The processor implements the above-described function, process and/or method. The processor 921 may be related to the memory 924 for storing a program code and data. The memory may be referred to as a computer-readable recording medium. More specifically, in the DL (communication from the first communication device to the second communication device), the transmission (TX) processor 912 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 910 using a method similar to that described in relation to a receiver function in the second communication device 920. Each Tx/Rx module 925 receives a signal through each antenna 926. Each Tx/Rx module provides an RF carrier and information to the RX processor 923. The processor 921 may be related to the memory 924 for storing a program code and data. The memory may be referred to as a computer-readable recording medium.

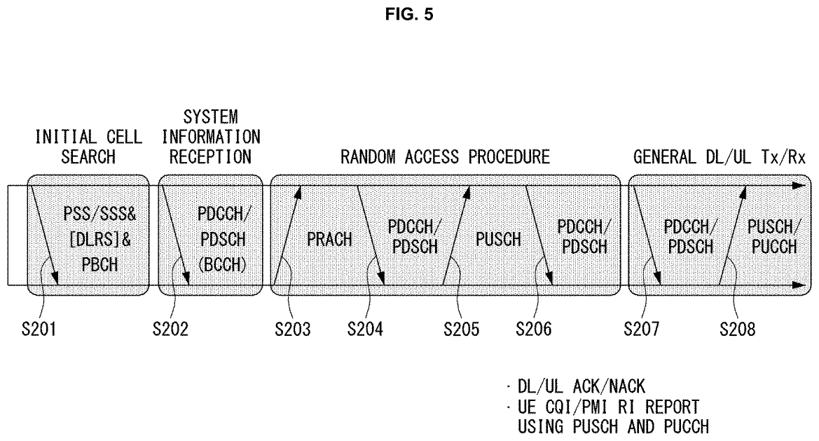

Aspects of the present disclosure are now provided with respect to a signal transmission/reception method in wireless communication system. FIG. 5 is a diagram showing an example of a signal transmission/reception method in a wireless communication system. For example, FIG. 5 shows the physical channels and general signal transmission used in a 3GPP system. In the wireless communication system, the terminal receives information from the base station through the downlink (DL), and the terminal transmits information to the base station through the uplink (UL). The information which is transmitted and received between the base station and the terminal includes data and various control information, and various physical channels exist according to a type/usage of the information transmitted and received therebetween.

When power is turned on or the terminal enters a new cell, the terminal performs initial cell search operation such as synchronizing with the base station (S201). To this end, the terminal may receive a primary synchronization signal (PSS) and a secondary synchronization signal (SSS) from the base station to synchronize with the base station and obtain information such as a cell ID. Thereafter, the terminal may receive a physical broadcast channel (PBCH) from the base station to obtain broadcast information in a cell. Meanwhile, the terminal may check a downlink channel state by receiving a downlink reference signal (DL RS) in an initial cell search step. After the terminal completes the initial cell search, the terminal may obtain more specific system information by receiving a physical downlink control channel (PDSCH) according to a physical downlink control channel (PDCCH) and information on the PDCCH (S202).

When the terminal firstly connects to the base station or there is no radio resource for signal transmission, the terminal may perform a random access procedure (RACH) for the base station (S203 to S206). To this end, the terminal may transmit a specific sequence to a preamble through a physical random access channel (PRACH) (S203 and S205), and receive a response message (RAR (Random Access Response) message) for the preamble through the PDCCH and the corresponding PDSCH. In case of a contention-based RACH, a contention resolution procedure may be additionally performed (S206).

After the terminal performs the procedure as described above, as a general uplink/downlink signal transmission procedure, the terminal may perform a PDCCH/PDSCH reception (S207) and physical uplink shared channel (PUSCH)/physical uplink control channel (PUCCH) transmission (S208). In particular, the terminal may receive downlink control information (DCI) through the PDCCH. Here, the DCI includes control information such as resource allocation information for the terminal, and the format may be applied differently according to a purpose of use.

Meanwhile, the control information transmitted by the terminal to the base station through the uplink or received by the terminal from the base station may include a downlink/uplink ACK/NACK signal, a channel quality indicator (CQI), a precoding matrix index (PMI), and a rank indicator (RI), or the like. The terminal may transmit the above-described control information such as CQI/PMI/RI through PUSCH and/or PUCCH.

An initial access (IA) procedure in a 5G communication system is additionally described with reference to FIG. 5. A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described. SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5. A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

A beam management (BM) procedure of 5G communication system is now described. A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described. The configuration of beam reporting using an SSB is performed when a channel state information (CSI)/beam configuration is performed in RRC_CONNECTED. A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.

The UE receives signals on the SSB resources from the BS based on the CSI-SSB-ResourceSetList. If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described. An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described. The UE receives an NZP CSI-RS resource set IE, including an RRC parameter regarding “repetition”, from a BS through RRC signaling. In this case, the RRC parameter “repetition” has been set as “ON.” The UE repeatedly receives signals on a resource(s) within a CSI-RS resource set in which the RRC parameter “repetition” has been set as “ON” in different OFDM symbols through the same Tx beam (or DL spatial domain transmission filter) of the BS. The UE determines its own Rx beam. The UE omits CSI reporting. That is, if the RRC parameter “repetition” has been set as “ON”, the UE may omit CSI reporting.

Next, the Tx beam determination process of a BS is described. A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.

The UE receives signals on resources within a CSI-RS resource set in which the RRC parameter “repetition” has been set as “OFF” through different Tx beams (DL spatial domain transmission filter) of the BS. The UE selects (or determines) the best beam. The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described. A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.

The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.

If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described. In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-reliable and low latency communication (URLLC) are now described. URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by positionInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE. When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC) are now described. Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH. That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

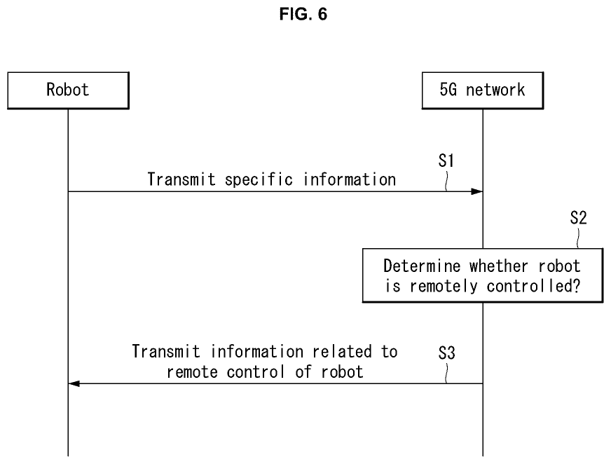

Robot basic operation using 5G communication are now described. FIG. 6 shows an example of a basic operation of the robot and a 5G network in a 5G communication system. A robot transmits specific information transmission to a 5G network (S1). Furthermore, the 5G network may determine whether the robot is remotely controlled (S2). In this case, the 5G network may include a server or module for performing robot-related remote control. Furthermore, the 5G network may transmit, to the robot, information (or signal) related to the remote control of the robot (S3).

Application operation between robot and 5G network in 5G communication system are now described. Hereafter, a robot operation using 5G communication is described more specifically with reference to FIGS. 1 to 6 and the above-described wireless communication technology (BM procedure, URLLC, mMTC).

First, a basic procedure of a method to be proposed later in the present disclosure and an application operation to which the eMBB technology of 5G communication is applied is described. As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the present disclosure and an application operation to which the URLLC technology of 5G communication is applied is described below. As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the present disclosure and an application operation to which the mMTC technology of 5G communication is applied is described below. A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

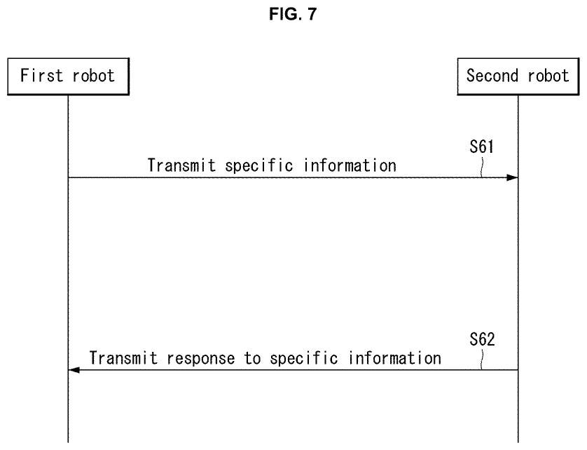

Operation between robots using 5G communication is described. FIG. 7 illustrates an example of a basic operation between robots using 5G communication. A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below. First, a method for a 5G network to be directly involved in the resource allocation of signal transmission/reception between robots is described. The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below. A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the unmanned aerial robot, the 5G communication technology, etc. may be combined with methods to be described, proposed in the present disclosures, and may be applied or may be supplemented to materialize or clarify the technical characteristics of methods proposed in the present disclosures.

Some terms related to a drone are not described. For example, an unmanned aerial system corresponds to a combination of a UAV and a UAV controller. The unmanned aerial vehicle may correspond to an aircraft that is remotely piloted without a human pilot, and it may be represented as an unmanned aerial robot, a drone, or simply a robot. A UAV controller may be a device used to control a UAV remotely. ATC may correspond to Air Traffic Control. NLOS may correspond to Non-line-of-sight. UAS may correspond to Unmanned Aerial System. UAV may correspond to Unmanned Aerial Vehicle. UCAS may correspond to Unmanned Aerial Vehicle Collision Avoidance System. UTM may correspond to Unmanned Aerial Vehicle Traffic Management. C2 may correspond to Command and Control

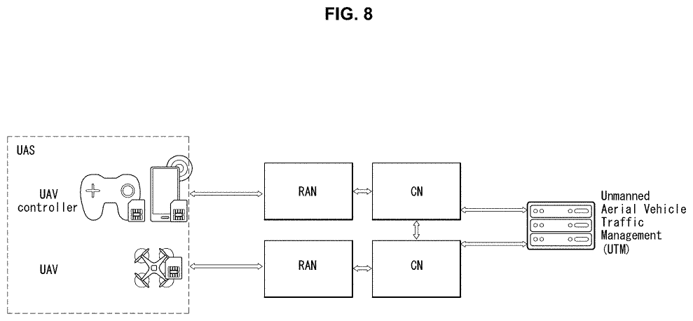

FIG. 8 is a diagram showing an example of the concept diagram of a 3GPP system including a UAS. An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information. Control information may include a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows. A 3GPP system enables the UAS to transmit different UAS data to UTM based on different certification and an authority level applied to the UAS. A 3GPP system supports a function of expanding UAS data transmitted to UTM along with future UTM and the evolution of a support application. A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection. A 3GPP system enables the UE of a UAS to transmit an identity, such as an IMEI, MSISDN or IMSI or IP address, to UTM.

A 3GPP system enables a mobile network operator (MNO) to supplement data transmitted to UTM, along with network-based location information of a UAV and a UAV controller. A 3GPP system enables MNO to be notified of a result of permission so that UTM operates. A 3GPP system enables MNO to permit a UAS certification request only when proper subscription information is present. A 3GPP system provides the ID(s) of a UAS to UTM. A 3GPP system enables a UAS to update UTM with live location information of a UAV and a UAV controller.

A 3GPP system provides UTM with supplement location information of a UAV and a UAV controller. A 3GPP system supports UAVs, and corresponding UAV controllers are connected to other PLMNs at the same time. A 3GPP system provides a function for enabling the corresponding system to obtain UAS information on the support of a 3GPP communication capability designed for a UAS operation. A 3GPP system supports UAS identification and subscription data capable of distinguishing between a UAS having a UAS capable UE and a USA having a non-UAS capable UE. A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

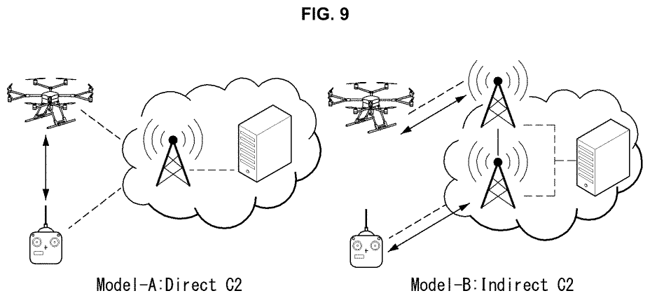

FIG. 9 shows examples of a C2 communication model for a UAV. Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV traffic management is now described. In a Centralized UAV traffic management, a 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

In a De-centralized UAV traffic management, a 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.

A 3GPP system supports a UAV in order to transmit a message through a network connection for identification between different UAVs. The UAV preserves owner's personal information of a UAV, UAV pilot and UAV operator in the broadcasting of identity information.

A 3GPP system enables a UAV to receive local broadcasting communication transmission service from another UAV in a short distance. A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.

A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.

A 3GPP system supports the direct UAV versus UAV local broadcast communication transmission service capable of guaranteeing separation between UAVs. In this case, the UAVs may be considered to have been separated if they are in a horizontal distance of at least 50m or a vertical distance of 30m or both. The 3GPP system supports the direct UAV versus UAV local broadcast communication transmission service that supports the range of a maximum of 600m.

A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms. A UAV may broadcast its own identity locally at least once per second, and may locally broadcast its own identity up to a 500 m range.

For security, a 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

For 3GPP support for aerial UE (or drone) communication, an E-UTRAN-based mechanism that provides an LTE connection to a UE capable of aerial communication is supported through the following functions. Subscription-based aerial UE identification and authorization may be defined in Section TS 23.401, 4.3.31.

Height reporting based on an event in which the altitude of a UE exceeds a reference altitude threshold configured with a network. Interference detection based on measurement reporting triggered when the number of configured cells (i.e., greater than 1) satisfies a triggering criterion at the same time.

For signaling of flight route information from a UE to an E-UTRAN, location information reporting including the horizontal and vertical velocity of a UE may be used. For (1) Subscription-based identification of aerial UE function, the support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

For (2) Height-based reporting for aerial UE communication, an aerial UE may be configured with event-based height reporting. The aerial UE transmits height reporting when the altitude of the UE is higher or lower than a set threshold. The reporting includes height and a location.

For (3) Interference detection and mitigation for aerial UE communication, for interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

For (4) Flight route information reporting, an E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

For (5) Location reporting for aerial UE communication, Location information for aerial UE communication may include a horizontal and vertical velocity if they have been configured. The location information may be included in the RRM reporting and the height reporting.

Hereafter, (1) to (5) of 3GPP support for aerial UE communication is described more specifically. With DL/UL interference detection, for DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

For DL interference mitigation, in order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles.

In the viewpoint that a LOS direction between an aerial UE and a serving cell is tracked, the following types of capability are taken into consideration: 1) Direction of Travel (DoT): an aerial UE does not recognize the direction of a serving cell LOS, and the antenna direction of the aerial UE is aligned with the DoT; 2) Ideal LOS: an aerial UE perfectly tracks the direction of a serving cell LOS and pilots the line of sight of an antenna toward a serving cell; and 3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

For UL interference mitigation, in order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents: UE-specific partial pathloss compensation factor; UE-specific Po parameter; Neighbor cell interference control parameter; Closed-loop power control.

The power control-based mechanism for UL interference mitigation is described more specifically. For 1) UE-specific partial pathloss compensation factor, the enhancement of the existing open-loop power control mechanism is taken into consideration in the place where a UE-specific partial pathloss compensation factor α_{UE} is introduced. Due to the introduction of the UE-specific partial pathloss compensation factor α_{UE}, different α_{UE} may be configured by comparing an aerial UE with a partial pathloss compensation factor configured in a terrestrial UE.

For 2) UE-specific PO parameter, Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation.

Accordingly, the UE-specific partial pathloss compensation factor α_{UE} and the UE-specific Po can improve the uplink throughput of a terrestrial UE, while scarifying the reduced uplink throughput of an aerial UE.

For 3) Closed-loop power control, target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked: 1) Direction of Travel (DoT): an aerial UE does not recognize the direction of a serving cell LOS, and the antenna direction of the aerial UE is aligned with the DoT; 2) Ideal LOS: an aerial UE perfectly tracks the direction of a serving cell LOS and pilots the line of sight of the antenna toward a serving cell; and 3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility: Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.

Improvement of a handover procedure for an aerial UE and/or mobility of a handover-related parameter based on location information and information, such as the aerial state of a UE and a flight route plan A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

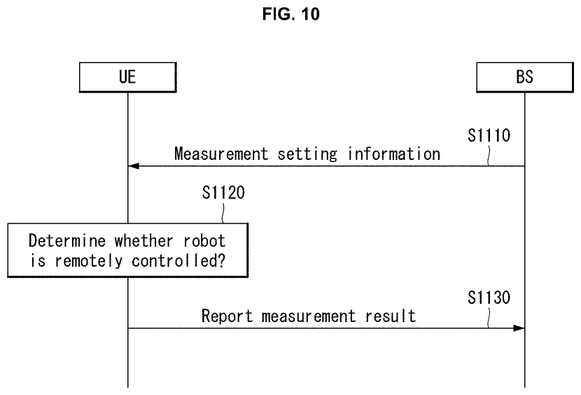

A measurement execution method which may be applied to an aerial UE is described more specifically. FIG. 10 is a flowchart showing an example of a measurement execution method to which the present disclosure may be applied. An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2. Event H1 (aerial UE height exceeding a threshold): A UE considers that an entering condition for the event is satisfied when 1) the following defined condition H1-1 is satisfied, and considers that a leaving condition for the event is satisfied when 2) the following defined condition H1-2 is satisfied.

Inequality H1-1(entering condition): Ms−Hys>Thresh+Offset

Inequality H1-2(leaving condition): Ms+Hys<Thresh+Offset

In the above equation, the variables are defined as follows. Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (aerial UE height of less than threshold): A UE considers that an entering condition for an event is satisfied 1) the following defined condition H2-1 is satisfied, and considers that a leaving condition for the event is satisfied 2) when the following defined condition H2-2 is satisfied.

Inequality H2-1(entering condition): Ms+Hys<Thresh+Offset

Inequality H2-2(leaving condition): Ms−Hys>Thresh+Offset

In the above equation, the variables are defined as follows. Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on a parameter for configuring filtering of a measurement unit, a reporting unit and/or a measurement result value. (5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1
-- ASN1START.....MeasParameters-v1530 ::= SEQUENCE {qoe-MeasReport-r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED
{supported} OPTIONAL, multipleCellsMeasExtension-r15 ENUMERATED
{supported} OPTIONAL}.....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE identification: A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription handling for aerial UE: The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling. In the case of Inter-RAT handover to intra- and inter-MME handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling. In the case of X2-based handover, aerial UE subscription information of a user is transmitted to a target BS as follows: If a source BS supports the aerial UE function and aerial UE subscription information of a user is included in UE context, the source BS includes corresponding information in the X2-AP handover request message of a target BS. An MME transmits, to the target BS, the aerial UE subscription information in a Path Switch Request Acknowledge message.

An object of a handover resource allocation procedure is to secure, by a target BS, a resource for the handover of a UE. If aerial UE subscription information is changed, updated aerial UE subscription information is included in an S1-AP UE context modification request message transmitted to a BS. Table 2 is a table showing an example of the aerial UE subscription information.

TABLE 2

| | | | |
|---|---|---|---|
| IE/Group Name | Presence | Range | IE type and reference |

| | | |
|---|---|---|
| Aerial UE subscription | M | ENUMERATED |
| information | | (allowed, not |
| | | allowed, . . .) |

Aerial UE subscription information is used by a BS in order to know whether a UE can use the aerial UE function.

Combination of drone and eMBB: A 3GPP system can support data transmission for a UAV (aerial UE or drone) and for an eMBB user at the same time. A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

Hereinafter, the unmanned aerial robot is referred to as a drone. In order to perform indoor or outdoor positioning by using a drone, precise position control of the flying drone is required to accurately measure a measurement space to be measured. However, when the drone is flying indoors, it may be difficult to receive a global positioning system (GPS) signal due to a weak strength of the GPS signal.

In this case, since the drone may not receive the GPS signal, a problem may occur that GPS-based position control which is generally used in outdoor flights is difficult, and when the drone is flying within a specific structure, a separate method is needed to find the position of the drone. In addition, in the case of image-based position control using only a conventional marker (light source), as the distance between the marker and the drone increases, the position measurement precision decreases, making it difficult to control the position of the drone, which causes a problem that the flight performance of the drone decreases.

In addition, when the drone uses a cloud mapping method using a lidar in an indoor environment, if a reference coordinate is not set, an error occurring during the flight of the drone may be reflected in the mapping result, and when the horizontal axis of the position, which is the reference point of the absolute coordinates of the drone, is shaken or changed, a large amount of error occurs in the mapping result.

For example, in the case of performing positioning on a narrow measurement space such as space positioning for elevator installation, it is necessary to precisely manage the measurement error. In addition, in order to increase or decrease the altitude only in the vertical direction in the narrow measurement space without repositioning, it is necessary to minimize the error occurrence of the drone. That is, when the set absolute coordinates are changed during the flight of the drone, since the error of the entire data greatly occurs, it is necessary to correct the change of the absolute coordinates in real time through the control using the sensor.

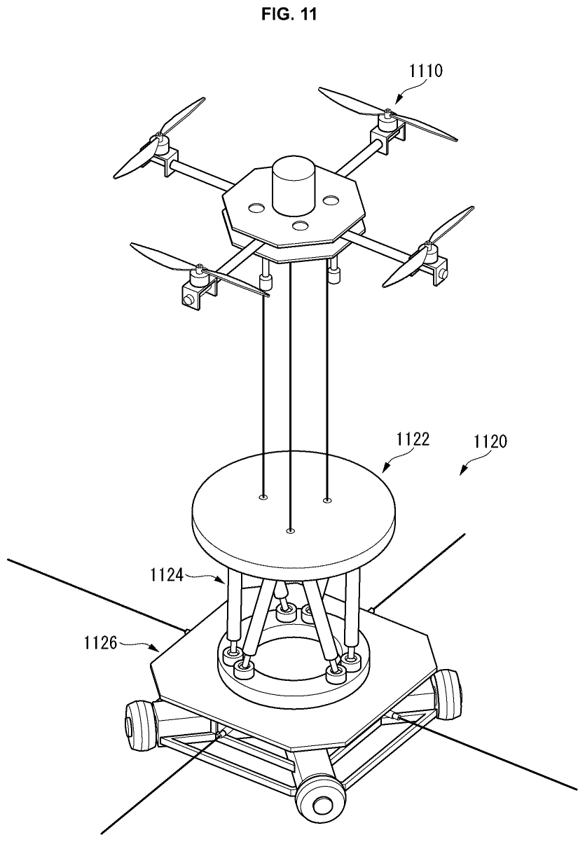

The method of precisely controlling the drone for performing positioning on the indoor or outdoor space will be described below. FIG. 11 shows an example of a drone for positioning and a drone station according to an embodiment of the present disclosure. Referring to FIG. 11, a flight system for indoor or outdoor positioning may include a drone 1110 for performing positioning on the measurement space through flight and a station providing a center position for precise control of the drone's takeoff and landing and position of the drone 1110.

Specifically, a station 1120 for takeoff and landing and battery charging of the drone 1110 may include a takeoff and landing area 1122 for takeoff and landing of the drone, a horizontality maintaining device 1124 for maintaining horizontality of the station in a measurement space for measuring, a horizontal moving device 1126 for changing the position of the station, and a charging device (not shown) for battery charging of the drone.

When performing positioning on a specific room (hereinafter, referred to as a measurement space), the station 1120 may be a standard for determining the position of the drone 1110. For example, the drone 1110 may stay at the takeoff and landing area 1122 of the station 1120, and then take off from the station 1120 when positioning on the measurement space is started to perform positioning on the measurement space.

In this case, the drone 1110 may determine whether the horizontal axis position of the drone 1110 has changed after starting of the flight based on the position of the station 1120. For example, when the drone 1110 performs positioning on the measurement space while making vertical flight from the position of the station 1120 after takeoff, the drone 1110 may recognize whether the drone is currently flying only on the vertical axis without movement of the horizontal axis position, based on the station 1120.

Accordingly, the station 1120 determines whether the position where the drone 1110 attempts to measure is correct or whether the station 1120 is horizontal, based on the horizontality maintaining device 1124, and when the station is not horizontal, the horizontality maintaining device may be used such that the horizontality of the station 1120 is maintained.

When the drone 1110 performs positioning on the measurement space while flying vertically from the center position of the measurement space, the station 1120 may be a standard for determining whether the current position of the drone 1110 is the center position of the measurement space. Accordingly, the station 1120 is required to be located at the center position of the measurement space before the drone 1110 takes off. To this end, the station 1120 may measure a distance to each wall surface in order to be located at the center position of the measurement space and move to the center position of the measurement space based on the measured distance.

The station 1120 may include a plurality of laser points in the takeoff and landing area 1122 to generate a plurality of laser beams such that the drone 1110 recognizes the position of the station, and the horizontality maintaining device 1124 for maintaining horizontality of the station 1120 may include a mechanism and a controller.

For example, the plurality of laser points may be guide lasers for the generation of three or more laser beams, and the takeoff and landing area 1122 may include a guide marker and a laser pointer. In addition, the horizontality maintaining device 1124 may include a degree-of-freedom (DOF) motion platform or a horizontal device using pneumatic pressure.

In addition, when the station 1120 is not located at the center position, the horizontal moving device 1126 for movement may include an omni wheel and a laser sensor. In this case, the station 1120 may determine whether the station 1120 is at the center position by generating a laser beam to each wall surface of the measurement space by using the laser sensor provided in the horizontal moving device 1126.

Specifically, the station 1120 measures a distance to each wall surface of the measurement space by using the laser sensor, and the center of the station is adjusted to a point where the value of the sensor is minimum. In this case, the station 1120 may move to the center position by using the omni wheel. The omni wheel may be repositioned without orientation on the xy plane, may be quickly corrected for position error, and may change direction without rotation, which makes it possible to perform quick horizontal and vertical control.

The drone 1110 and the station 1120 may be used to perform precise positioning on the indoor space. In addition, although not shown in FIG. 11, the station 1110 may further include a charging device (not shown) for battery charging of the drone. The charging device may include a wired charging device and/or a wireless charging device, and charge the battery of the drone while the drone is stays in a landing state in the station.

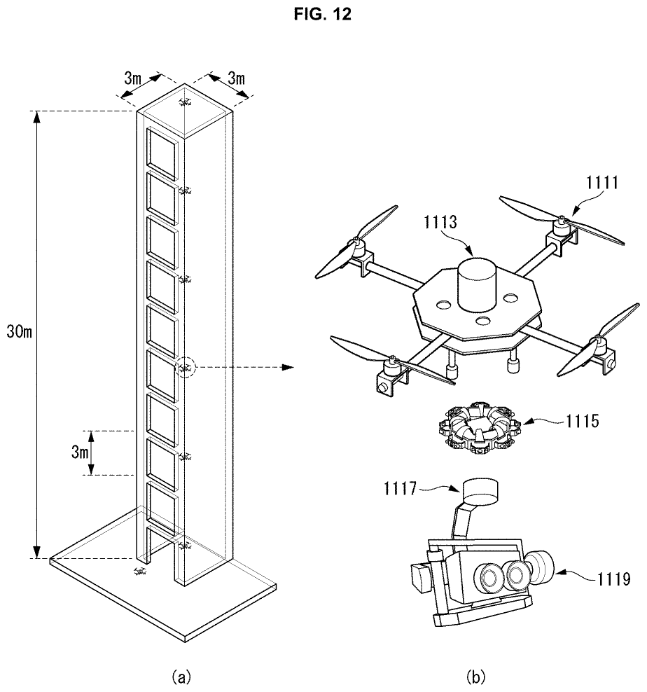

FIG. 12 shows an example of main components of the drone for positioning according to the embodiment of the present disclosure. Referring to FIG. 12, the drone 1110 may perform positioning on the measurement space according to the altitude through a vertical flight.

Specifically, as shown in FIG. 12(b), the drone 1110 for indoor or outdoor positioning may be provided with a flying body 1111 for flying, a positioning device 1113 for positioning, a sensor 1115 for positioning in indoor flight of the drone 1110, a gimbal 1117 for vibration suppression, attitude maintenance, and 3-axis (X, Y, Z-axis) control of the drone 1110, and a camera 1119 for photographing an image.

The positioning device 1113 may perform an operation for a task that the drone 1110 should perform to provide a specific service (for example, indoor or outdoor positioning). For example, as shown in FIG. 12(a), when the drone performs positioning on a narrow room, the positioning device 1113 may be a sensor (second sensor or 3D light detection and ranging (lidar) sensor) for indoor positioning. The lidar sensor is a sensor using a sensing technology for detecting remote objects and measuring distances by using a light source and a receiver. When a light pulse (for example, a laser) emitted from a light source hits an object and is reflected back to the lidar system, the receiver may detect the returned light pulse.

The time from transmission to reception of the light pulse may vary depending on the distance between the lidar system and the object, and the distance between the drone and the object may be calculated using the time from the transmission to the reception thereof.

In the indoor flight of the drone 1110, when the drone is flying vertically for indoor positioning, the sensor for positioning (first sensor, 1115) senses a plurality of laser beams transmitted from the station so that the drone 1110 does not deviate from the center position where the station is located. That is, in order for the drone 1110 to measure the distances from the center position to each wall surface at different heights in the narrow measurement space, the drone 1110 is needed to move only on the vertical axis from the reference position, which is set based on the position of the station, without movement of the horizontal axis and measure the distances to each wall surface while increasing the altitude. Accordingly, the drone 1110 may sense the plurality of laser beams generated from the station through the sensor 1115 in order not to deviate from the reference position.

When the number of sensed laser beams is less than the number of plurality of laser beams generated from the station or the position the drone is changed, the drone 1110 may recognize that the drone 1110 has deviated from the reference position, and move the position such that the plurality of laser beams transmitted from the station is sensed by the sensor 1115.

Specifically, the drone 1110 may fly vertically to measure the distance to each wall surface according to the altitude. In this case, in order to measure the distance from the center position to each wall surface in the measurement space, the drone 1110 may fly vertically by using the position of the station as a reference position.

In order to sense whether the drone deviates from the reference position, the drone 1110 first recognizes, through a camera, a plurality of laser beams generated from the station and/or a plurality of guide markers for position control, while flying vertically. When the plurality of laser beams and/or the plurality of guide markers are not all recognized through the camera, the drone 1110 recognizes that the drone has deviated from the reference position, and moves the position such that the plurality of laser beams and/or the plurality of guide markers are all recognized. Subsequently, in order to precisely adjust the position of the drone 1110, the drone 1110 senses the plurality of laser beams by using the sensor 1115, and determines whether the drone 1110 deviates from the reference position through the plurality of sensed laser beams. According to the determination, the drone 1110 is maintained in the reference position.

For example, the drone 1110 may sense the plurality of laser beams by using the sensor 1115, and determine how far the drone 1110 deviates from the reference position according to whether the plurality of laser beams are all sensed and the positions of the plurality of sensed laser beams. Subsequently, the drone 1110 may move to the reference position of the station based on the determination result of the drone 1110. In addition, the drone 1110 may calculate a distance to a position where each of the plurality of laser beams is generated by using the plurality of laser beams, and determine whether the drone is horizontal based on the calculated distance.

When the calculated distances are different from each other, the drone 1110 may recognize that the drone is not horizontal and adjust the left and right horizontality of the drone 1110 such that the calculated distances are equal to each other. For example, the drone 1110 may be maintained in the horizontal state by lowering the altitude on the shorter-distance side or lowering the altitude on the longer-distance side. Alternatively, the gimbal 1117 is used to control the X-axis and the Y-axis, and/or the Z-axis that are the horizontal and/or vertical axis to adjust the shorter-distance side or longer-distance side. Therefore, the attitude of the drone 1110 may be controlled so as to be horizontal.

The camera 1119 may be used, together with the positioning device 1113, to perform an operation for a task required to provide a specific service, or may be used, together with the sensor 1115, to allow the drone to fly vertically while maintaining the reference position. For example, when the camera 1119 is used to perform positioning on the narrow indoor space together with the positioning device 1113, the drone 1110 may photograph each wall surface of the measurement space by using the camera 1119 to obtain image information, and may obtain modeling (for example, 3D modeling information as shown in FIG. 12(a) of the measurement space through the positioning device 1113.

Subsequently, the result for the measurement space may be obtained by using the image information obtained through the camera 1119 and the modeling obtained through the positioning device 1113 together. In this case, since image information and modeling are used together, the image of the wall surface and a distance to the wall surface that is measured in detail may be obtained, such that specific positioning of the measurement space may be performed.

In addition, by recognizing the plurality of laser beams generated from the station and/or the plurality of guide markers displayed on the station through the camera 1119, the camera 1119 may be used for position control together with the sensor 1115 such that the drone 1110 is maintained in the center position of the measurement space.

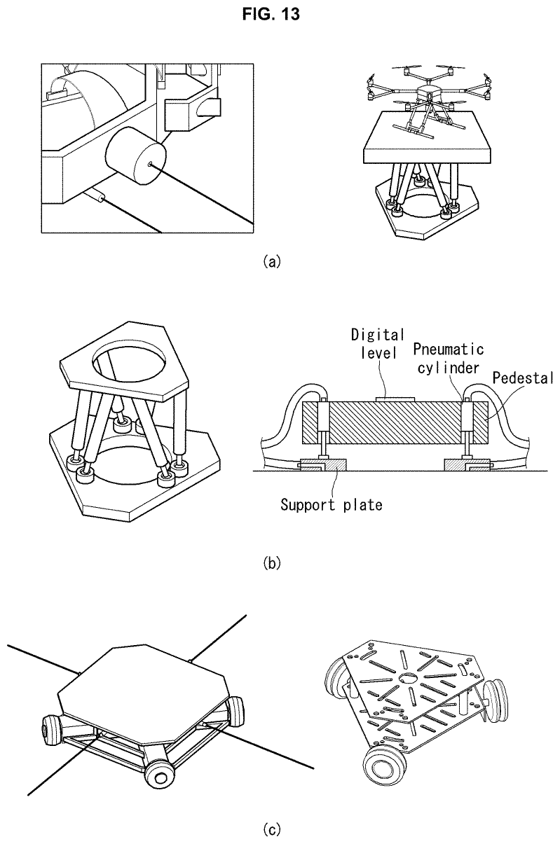

FIG. 13 shows an example of main components of the station for vertical flight of the drone according to the embodiment of the present disclosure. Referring to FIG. 13, an example of main components of the station described in FIG. 11 is shown.

FIG. 13(a) shows an example of the takeoff and landing area 1122 of the station described in FIG. 11 and a plurality of laser pointers provided therein. In FIG. 13(a), the left side is an example of a plurality of laser pointers, and the plurality of laser pointers serves to guide the center position to the drone so that the drone does not deviate from the center position by the station. The right side in FIG. 13(a) shows an example of the takeoff and landing area 1122 provided with a plurality of laser pointers and markers.

The drone may recognize a plurality of laser beams and/or markers generated from the plurality of laser pointers provided in the takeoff and landing area 1122 by a camera to control the position of the drone (coarse control), primarily, and recognize the plurality of laser beams by a sensor to precisely control the position of the drone, secondarily.

FIG. 13(b) shows an example of the horizontality maintaining device 1124 described in FIG. 11. The horizontality maintaining device 1124 may be used to maintain the horizontal state of the station 1120 as described in FIG. 11. In FIG. 13(b), the left side shows an example of a six DOF motion platform, and the right side shows an example of a horizontal device using pneumatic pressure. As shown in FIG. 13(b), the horizontal device using pneumatic pressure determines whether the station is horizontal by using a digital level, if not horizontal, the horizontal device may make the station horizontal by adjusting the height of a pedestal using a pneumatic cylinder.

FIG. 13(c) shows an example of the horizontal moving device 1126 described in FIG. 11, and in FIG. 13(c), the left side shows an example of a four-wheel horizontal moving device, and the right side shows an example of a three-wheel horizontal moving device. The horizontal moving device 1126 may include a laser sensor and an omni wheel.

The station may determine whether the station is located at the center position of the measurement space by using a laser sensor, and if not located at the center position, the station may move to the center position by using the omni wheel. Specifically, when the station determines that the station is not located at the center position of the measurement space by using the laser sensor, the station may move its position by using the omni wheel of the horizontal moving device 1126.

In this case, the station may move to the center position based on the distance measured using the laser sensor. For example, when the distance to a specific wall surface is short or long among the distances measured using the laser sensor, the station may move toward the shorter side to be located at the center position where the distances from the station to respective wall surfaces are equal to each other.

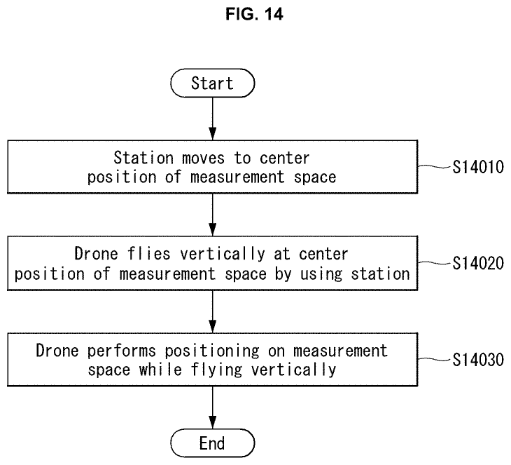

FIG. 14 is a flowchart showing an example of a positioning method using vertical flight according to the embodiment of the present disclosure. Referring to FIG. 14, in the flight system of the drone, which includes the drone, the station, and the server, the drone may fly vertically while maintaining the center position at the measurement space by using the station, and transmit, to the server, the measurement result for the measurement space, which is measured according to the altitude through the vertical flight.

Specifically, the station provided with the drone may move to the center position of the measurement space, which is the reference position of the vertical flight of the drone (S14010). As described in FIGS. 11 and 13, the station may determine whether the station is located at the center position of the measurement space by using the laser sensor of the horizontal moving device, and may move to the center position by using the omni wheel. Subsequently, when the drone starts vertical flight, the station may generate the plurality of laser beams by using the plurality of laser pointers of the takeoff and landing area.

When the station moves to the center position, the drone flies vertically at the center position of the measurement space by using the station (S14020). As described in FIGS. 11 and 12, the drone may fly vertically while maintaining the center position of the measurement space by sensing a plurality of markers and/or a plurality of laser beams of the station by using a camera and/or a sensor.

The drone may perform positioning on the measurement space while flying vertically at the center position (S14030). As described in FIG. 12, the drone may obtain image information on the measurement space through a camera, and may obtain modeling of the measurement space by using a measuring device (for example, a 3D lidar system).

Subsequently, the drone may obtain the final measurement result for the measurement space by using the obtained image information and the measuring device. That is, the final measurement result for the measurement space may be derived by combining the image information and the modeling, and the derived measurement result may be transmitted to the server.

In another embodiment according to the present disclosure, the drone may obtain path information related to the flight path of the drone for the measurement space from the server before takeoff for vertical flight. The drone may measure the measurement space while flying based on the path information obtained from the server. Using above-described method, the drone may fly vertically while maintaining the center position of the measurement space, and may precisely measure the measurement space by using the lidar system as well as the camera.

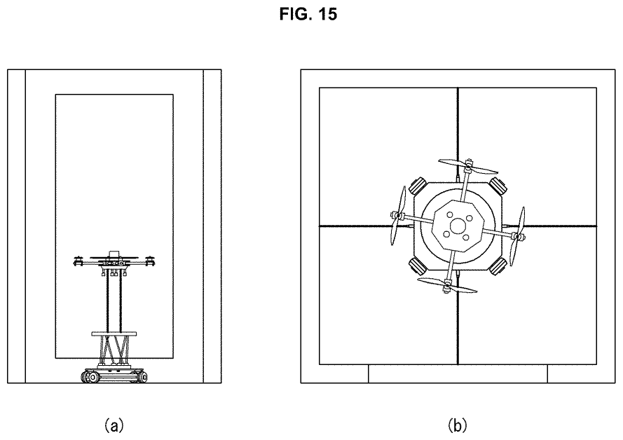

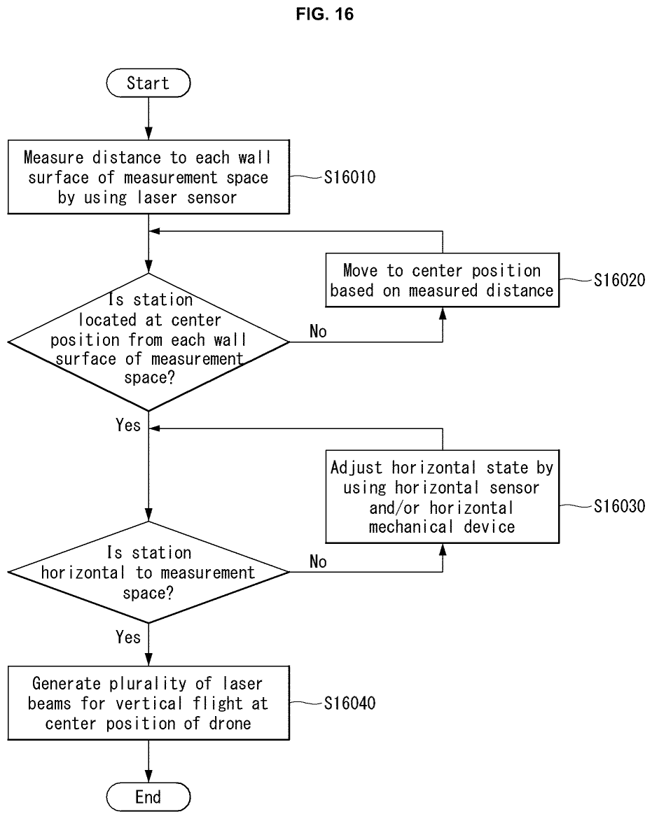

FIGS. 15 and 16 show examples of a method for locating the station at the center position of a measurement space for vertical flight of an unmanned aerial robot according to the embodiment of the present disclosure. Referring to FIG. 15, the station may generate a plurality of laser beams by using a plurality of laser pointers at the center position in order to allow the drone to fly vertically at the center position of the measurement space as shown in FIG. 15(a). To this end, the station may move to the center position of the measurement space as shown in FIG. 15(b).

Hereinafter, a measurement space having four sides will be described as an example. The measurement space is only an example, and the station may be moved to the center position by using the method described below in a measurement space composed of a plurality of sides in addition to four sides.

As described in FIGS. 11 and 13, the station may calculate a distance from its current position to each of the sides by using a plurality of laser sensors provided in a horizontal movement state when the drone is in a landed state. For example, the station may generate a laser beam to each side by using a plurality of laser sensors, and may sense a reflected beam obtained by reflecting the generated laser beam by each side through the laser sensor. The station may calculate the distance to each side by calculating the time that the laser beam transmitted to each side is reflected back, and compare the distances to the sides with each other and determine whether the station is in the center position.

Alternatively, when the measurement space is not square, it may be determined whether the station is in the center position by comparing the lengths of the sides with the opposite sides, respectively. For example, when the length of one side is shorter than the length of the opposite side, the station may determine that the station is biased toward the side having a shorter length.

In this case, the omni wheel is used such that the station moves to a position where the lengths to the sides are the same or the length to one side is the same as the length to the opposite side. Accordingly, the station may move to the center position.

Subsequently, when the station moves to the center position, the drone may take off. When the drone takes off, the station may generate a plurality of laser beams by using a plurality of laser pointers provided in the takeoff and landing area, such that the drone may fly vertically from the center position.

FIG. 16 is a flowchart illustrating the method described in FIG. 15, and the station may measure a distance to each wall surface of the measurement space by using a plurality of laser sensors to determine whether the current position is the center position of the measurement space (S16010). The station may determine whether the position of the station is a center position from each wall surface of the measurement space based on the measured distance to each wall surface. For example, as described in FIG. 15, the station may calculate the distance to each surface by calculating the time that the laser beam transmitted to each surface is reflected back, and determine whether the station is at the center position by comparing the distances to respective surfaces.

Alternatively, when the measurement space is not square, it may be determined whether the station is at the center position by comparing the length to each side with the length to the corresponding opposite side. For example, when the length to one side is shorter than the length to the opposite side, the station may determine that the station is biased toward the side having the shorter length.

When the station determines that it is not located at the center position, the station may move to the center position of the measurement space based on the measured distance (S16020). For example, the station may move to the center position by using the omni wheel to a position where the lengths to the sides are the same or the length to one side and the opposite side is the same. Alternatively, the station may move to the center position by using the omni wheel to a position where the length to each side is the same or the length to one side and the opposite side is the same.

The station which has moved to the center position of the measurement space may determine, by using a horizontality maintaining device, whether the station is horizontal with the floor surface of the measurement space, and when the station is not horizontal therewith, the station may make adjustment for the horizontal state by using the horizontality maintaining device described in FIGS. 11 and 13 (S16030).

For example, when the station is not horizontal, the station may adjust the height by a pneumatic cylinder on the inclined side in a pneumatic-pressure horizontal device, which is a horizontality maintaining device. Thereby, the station may be adjusted to be horizontal with the floor surface. When the floor surface is horizontal with the station, the station may transmit a signal for takeoff to the server or the drone, and the drone may take off by receiving the signal indicating takeoff from the server or station.

Subsequently, the station may generate a plurality of laser beams in a vertical direction from a plurality of laser pointers provided in the takeoff and landing area so that the drone flies vertically without deviating from the center position (S16040). In addition, the drone may fly vertically while maintaining the center position by using a marker displayed on the takeoff and landing area and/or the plurality of laser beams generated from the plurality of laser pointers. Using above-described method, the station may determine whether the station is located at the center position of the measurement space, and when not located at the center position, the station may move to the center position.

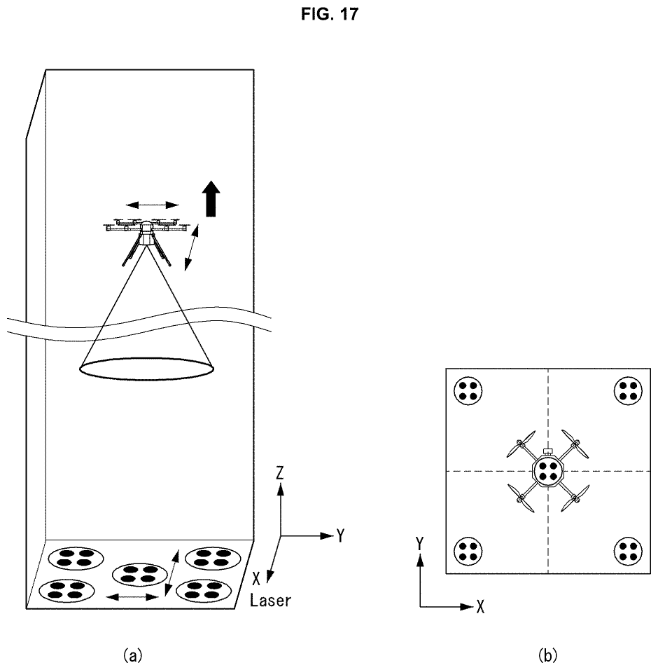

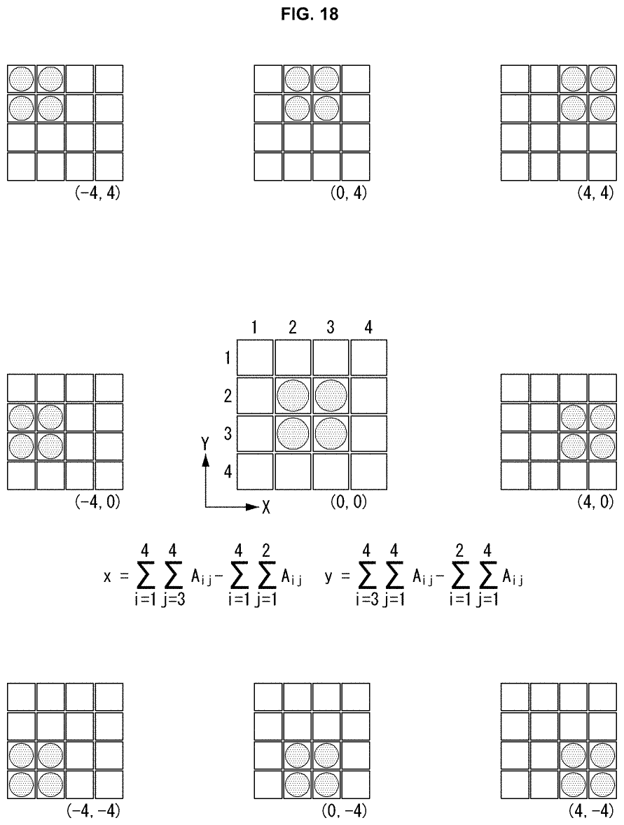

FIGS. 17 and 18 show examples of a method for causing the unmanned aerial robot to fly vertically while maintaining a horizontal axis position by using the station according to the embodiment of the present disclosure. Referring to FIG. 17, the drone may perform coarse control of moving to the position of the station by using markers displayed on the floor of the measurement space and/or the takeoff and landing area of the station, and when the position of the station is recognized, the drone may perform fine control of moving to the center position of the measurement>space where the drone is located by using a plurality of laser beams generated from the station.

Specifically, the drone may sense the relative position (for example, the attitude) between the drone and the station based on image information related to the marker of the measurement space, which is obtained by using a camera. The drone may move its position to the same position as the position of the station based on the sensed relative position.

Subsequently, the plurality of laser beams generated from the station, which is included in the marker, may be sensed through the sensor, and the position of the drone may be controlled to be accurately located at the center position of the measurement space regardless of the altitude of the drone. That is, since the laser beam may be transmitted over a long distance, the drone may sense the laser beam transmitted from the station through a sensor regardless of the altitude, and the sensor of the drone may be an optical sensor (for example, photodiode (PD)) for sensing the laser beam. In this case, the position of the drone may be controlled by moving a marker on the floor surface of the station or measurement space.

For example, as shown in FIG. 17(a), the drone may obtain image information by photographing a marker marked on the floor surface of the measurement space through a camera. In the marker shown in FIG. 17(a), a plurality of laser beams generated from a plurality of laser pointers may constitute one marker. In addition, although the marker is marked on the floor of the measurement space in FIG. 17(a), a plurality of laser pointers in the takeoff and landing area of the station may be also used as the marker.

The drone may recognize where the drone is located in the measurement space by using the obtained image information, and when the drone is not located at the center position of the measurement space, the drone may move the position so that the marker of the center position in FIG. 17(b) is photographed through the camera. In this way, the drone may recognize the relative position between the drone and the floor surface or the station, and may be controlled so that the drone is located at the center position of the measurement space based on the recognized relative position.

Subsequently, the drone may precisely control the attitude of the drone so that the drone is located at the accurate center position by using the plurality of laser beams generated at the floor surface of the center position or the station. Specifically, the drone may recognize the plurality of laser beams generated at the center position through a sensor (for example, an optical sensor or a first sensor), and control the position according to whether the plurality of laser beams is all recognized and the plurality of recognized laser beams is located at the center portion. This makes it possible to perform precise control to locate the drone at the center position of the measurement space.

For example, as shown in FIG. 18, the drone may recognize that the relative position of the drone is not the center position when the plurality of laser beams is all not recognized or a marker at a position other than the center position is recognized. In this case, the drone may primarily control movement of the drone by changing the position so that the marker at the center position is recognized.

Subsequently, when the plurality of laser beams included in the marker at the center position is all recognized, the drone may recognize which direction the recognized laser beam is biased. That is, when the plurality of recognized laser beams is not located at the position of (0,0) and is located at other positions, the drone determines that the current position is not the center position.

The drone may perform precise control such that the drone is accurately located at the center position of the measurement space (secondary control), by changing the position so that the plurality of laser beams is located at the position of (0,0). In this case, as shown in FIG. 18, the drone may calculate the position of the X-axis and the Y-axis through the following equation 1.

$$x = {\sum }_{i = 1}^{4} {\sum }_{j = 3}^{4} {A}_{ij} - {\sum }_{i = 1}^{4} {\sum }_{j = 1}^{2} {A}_{ij} , \\ y = {\sum }_{i = 3}^{4} {\sum }_{j = 1}^{4} {A}_{ij} - {\sum }_{i = 1}^{2} {\sum }_{j = 1}^{4} {A}_{ij} \qquad [ Equation 1 ]$$

In addition, as described above, the drone may measure the distance to each laser beam to recognize whether the attitude of the drone is horizontal. That is, when the distances to the respective laser beams are different from each other, the drone may determine that the current attitude is not horizontal, and adjust the attitude of the drone so that the distance using the respective laser beams is the same, thereby maintaining horizontality.

As described above, the drone may primarily recognize the relative position of the drone by using the image information through the camera and change its position to the position for precise control, and secondarily recognize the plurality of laser beams generated at the floor surface or the station through a sensor and perform precise control so that the drone may fly vertically while being accurately located at the center position.

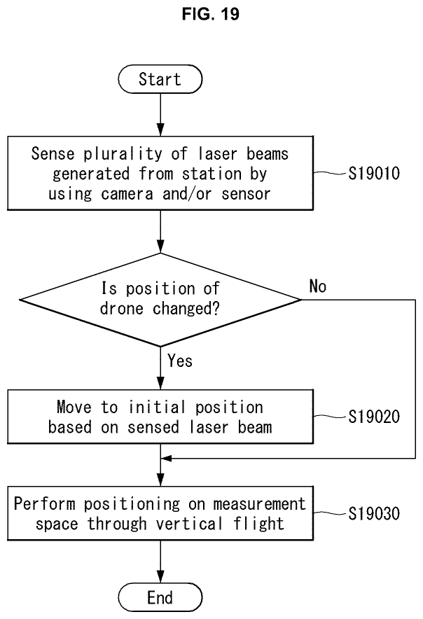

FIG. 19 is a flowchart showing an example of a method for causing the unmanned aerial robot to fly vertically while maintaining a horizontal axis position by using the station according to the embodiment of the present disclosure. Referring to FIG. 19, the drone may measure a measurement space according to the altitude by flying vertically while maintaining a reference position, which is a center position, by using a plurality of beams generated from the station through a camera and/or a sensor.

Hereinafter, in the present embodiment, it is assumed that the station has already moved to the center position of the measurement space through the method described in FIGS. 14 and 15. Specifically, the drone may take off from the station at the center position of the measurement space and then periodically or aperiodically sense the plurality of laser beams generated from the station by using a camera and/or a sensor (S19010).

The drone may recognize whether the current position of the drone has changed from the reference position, which is the center position when taking off, by using the plurality of sensed laser beams. That is, the drone may determine whether the position of the drone has changed by determining whether the plurality of laser beams is all recognized and whether the plurality of recognized laser beams is located at the center position.

When the position of the drone is not changed from the reference position, the drone performs a vertical flight to increase the altitude of the vertical axis while maintaining the horizontal axis position as a reference position, and measures the measurement space according to the altitude (S19030). However, when the position of the drone is changed from the reference position, the position of the drone may be controlled based on the sensed laser beam.

That is, according to the method described in FIGS. 17 and 18, the drone may move to the reference position, which is an initial position, by using the sensed laser beam (S19020), and after moving to the reference position, the drone performs vertical flight to increase the altitude of the vertical axis while maintaining the horizontal axis position at the reference position and measures the measurement space according to the altitude (S19030).

In addition, by calculating the distance to each of the plurality of laser beams generated from the station, the horizontal attitude of the drone may be controlled as described in FIG. 18. In order to measure the measurement position (hereinafter, referred to as a wall surface) according to the altitude, the drone may primarily obtain image information on each wall surface by photographing each wall surface through the camera of the drone.

Subsequently, the drone may secondarily obtain modeling information on each wall surface by using a measuring device (for example, a 3D lidar), and obtain the measurement result for each wall surface by using the obtained image information and modeling information together. That is, the drone may recognize the distance to and the shape of each wall surface by using the laser beam through the measuring device, and obtain modeling information on the measurement space by using the recognized result.

The drone may obtain specific measurement results for the measurement space by combining the obtained image information and modeling information, and transmit the obtained measurement results to a server or a station by using a wireless communication means. In this case, the wireless communication means may be a short range communication device (for example, Bluetooth) and/or a long range communication device (for example, LTE, LTE-A, Wi-Fi, and 5G).

Using above-described method, the drone may sense the drone deviating from the center position of the measurement space and precisely perform position control, and measure the measurement space by using image information and modeling information to obtain specific information on the measurement space.

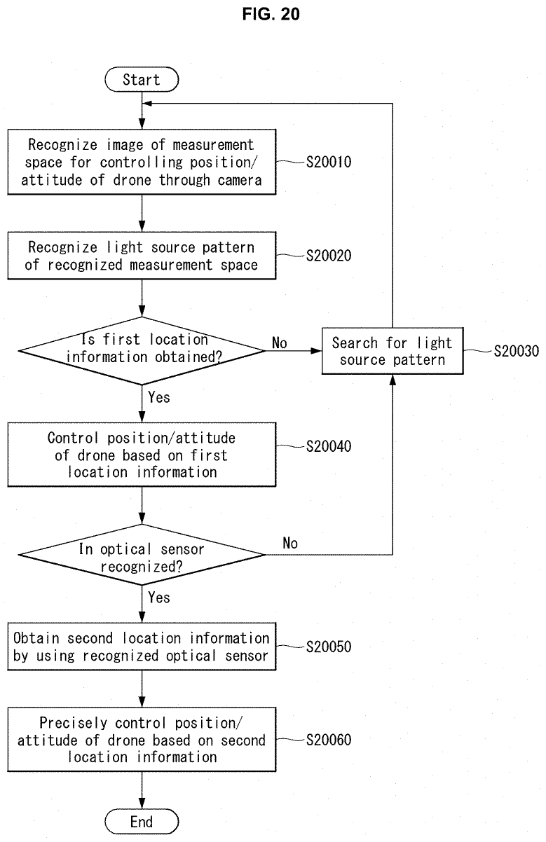

FIG. 20 is a flowchart showing another example of the method for causing the unmanned aerial robot to fly vertically while maintaining the horizontal axis position by using the station according to the embodiment of the present disclosure. Referring to FIG. 20, the drone may sense an image through a camera and a laser beam through a sensor to precisely control the position of the drone, such that the drone is accurately located at the center position of the measurement position.

Specifically, the drone may recognize an image of a measurement space by photographing the measurement space for controlling the position and/or attitude of the drone through the camera (S20010). That is, the drone may recognize markers displayed on a floor surface and/or the station by primarily obtaining image information by photographing the floor surface of the measurement space and/or the station by using a camera. In this case, the markers may include a plurality of laser beams generated by the plurality of laser pointers.

The drone may recognize whether markers, which is a light source pattern, are included in the image information of the measurement space recognized through the camera (S20020), and obtain first location information related to the relative position between the drone and the station or the floor surface according to whether the markers are included in the image information. That is, if the markers are not included in the image information, the drone may not obtain the first location information, and may search for the light source pattern again by using the camera (S20030).

When the first location information is obtained, the drone may recognize the relative position between the drone and the floor surface or the station based on the first location information, and the drone may recognize whether it is located at the reference position based on the recognized relative position, according to the method described in FIGS. 17 to 19.

The drone may control the position/attitude based on the first location information according to whether the drone is located at the reference position. That is, when the drone is not located at the reference position, the drone may move the position based on the laser beam generated from the floor surface or the station and control the position/attitude of the drone such that the drone is located at the center position (coarse control) (S20040).

When the drone moves to the reference position based on the first location information, the drone attempts to sense a plurality of laser beams forming the markers at the center position by using a sensor (optical sensor). When the plurality of laser beams are not all recognized through the optical sensor, the process returns to step S20030 again for the drone to search for the light source pattern again (S20030). However, when the plurality of lasers are all recognized through the optical sensor, second location information related to the current, precise position of the drone may be obtained by using the optical sensor recognizing the plurality of laser beams (S20050).

The drone may precisely control the position of the drone such that the plurality of laser beams is located at the center position of the sensing area sensed by the drone, as described in FIG. 18, based on the second location information (fine control) (S20060). That is, when the plurality of laser beams is not located at the center position of the sensing area sensed by the drone, the drone may change the horizontal axis position of the drone so that the plurality of laser beams is located at the center position of the sensing area sensed by the drone.

When a plurality of laser beams is located at the center position of the sensing area sensed by the drone, the drone performs a vertical flight to increase the altitude of the vertical axis while maintaining the horizontal axis position as a reference position, and measures the measurement space according to the altitude. In addition, by calculating the distance to each of the plurality of laser beams generated from the station, it is possible to control the horizontal attitude of the drone as described in FIG. 18.

In order to measure the measurement position (hereinafter, referred to as a wall surface) according to the altitude, the drone may primarily obtain image information on each wall surface by photographing each wall surface through the camera of the drone. Subsequently, the drone may secondarily obtain modeling information on each wall surface by using a measuring device (for example, a 3D lidar), and obtain the measurement result for each wall surface by using the obtained image information and modeling information together. That is, the drone may recognize the distance to and the shape of each wall surface by using the laser beam through the measuring device, and obtain modeling information on the measurement space by using the recognized result.

The drone may obtain specific measurement results for the measurement space by combining the obtained image information and modeling information, and transmit the obtained measurement results to a server or a station by using a wireless communication means. In this case, the wireless communication means may be a short range communication device (for example, Bluetooth) and/or a long range communication device (for example, LTE, LTE-A, Wi-Fi, and 5G).

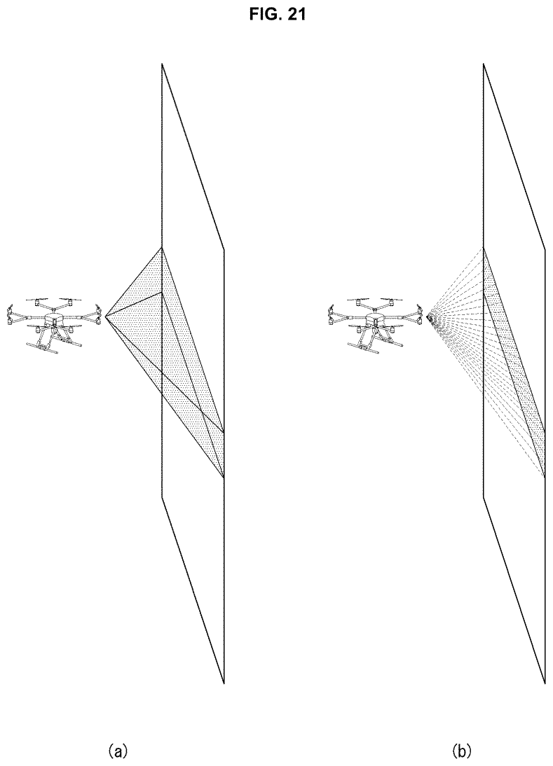

FIG. 21 is a diagram showing an example of a positioning method according to the embodiment of the present disclosure. Referring to FIG. 21, a drone may primarily obtain image information of wall surfaces of a measurement space by using a camera, and secondarily recognize the state of and distance to each of the wall surfaces by using a laser sensor (for example, a lidar sensor).

First, the station may be located at the center position of the measurement space based on the method described in FIGS. 11 to 20, and the drone may fix the horizontal axis position based on the center position of the station, and fly vertically for increasing the altitude on the vertical axis.

The drone may perform specific tasks to provide services to users while flying vertically. For example, when the drone is to provide a service for measuring a narrow space, the drone may periodically or aperiodically measure each wall surface of the measurement space according to the altitude while flying vertically, and the measured information may be transmitted to a server or a station by using a short range communication device or a long range communication device.

In this case, the drone may receive path information related to a flight path from the server or the station in advance. Specifically, the drone may obtain image information by photographing each of the wall surfaces using the camera while flying vertically, as shown in FIG. 21(a). The image information may be information photographed continuously while the drone increases the altitude, or may be image information of the wall surface photographed by the drone stopped at a specific altitude.

Subsequently, as shown in FIG. 21(b), the drone may obtain modeling information of the wall surface from which the image information is obtained through the lidar sensor as the measuring device. That is, the drone may obtain modeling information indicating the distance to each wall surface and the state of the wall surface through the measuring device.

The drone may obtain specific measurement results for the measurement space by using image information and modeling information together, and transmit the obtained measurement results to a server and/or a station. As such, specific positioning may be performed by using a precision measuring sensor such as a lidar sensor that is a laser sensor, as well as a camera.

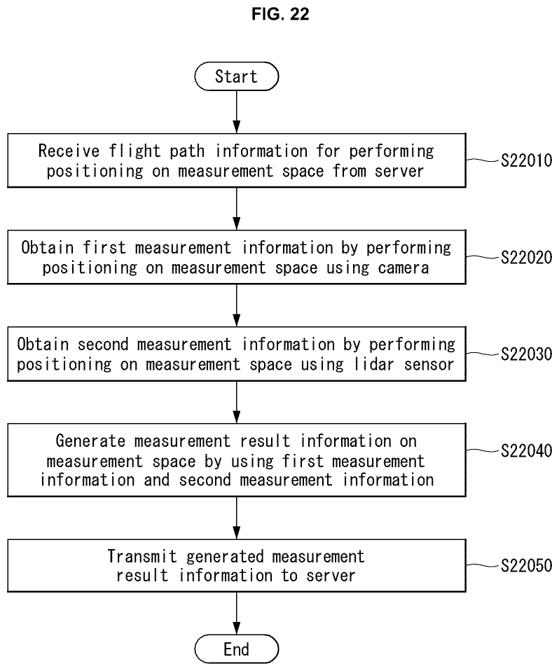

FIG. 22 is a flowchart showing an example of the positioning method according to the embodiment of the present disclosure. First, the station may be located at the center position of the measurement space based on the method described in FIGS. 11 to 20, and the drone may fix the horizontal axis position based on the center position of the station, and fly vertically for raising the altitude on the vertical axis.

In this case, the drone may receive, from the server or the station, flight path information related to the flight path for performing positioning on the measurement space, before starting the flight from the station (S22010). Step S22010 is an optional step, and may not be performed when the drone is simply flying vertically. Alternatively, when the drone flies vertically, the drone may sense the last measurement position through the vertical flight with the sensor mounted at the last position of the vertical flight or the sensor of the drone itself. When the measurement is ended at the last measurement position, the drone may land on the station again.

Then, the drone may fly vertically at the center position of the measurement space by using the camera and the sensor as in the method described in FIGS. 11 to 20. The drone may obtain first measurement information by performing positioning on the measurement space by photographing the measurement space using a camera according to the altitude while flying vertically (S22020). The first measurement information may be image information through the camera.

Then, the drone may obtain second measurement information by performing positioning on the measurement space using the lidar sensor (S22030). The second measurement information is obtained by using a laser beam through a lidar sensor, and is information allowing a distance to and a state of each wall surface of the measurement space to be specifically recognized. In this case, the second measurement information may be modeling information.

After the drone obtains the first measurement information and the second measurement information, the drone generates measurement result information on the measurement space by using the first measurement information and the second measurement information (S22040). That is, the drone may combine the image information, which is the first measurement information, and the modeling information, which is the second measurement information, to generate measurement result information including specific information, such as a distance to and an image and a state of the measurement space. Subsequently, the drone may transmit the generated measurement result information to the server and/or station by using wireless communication means.

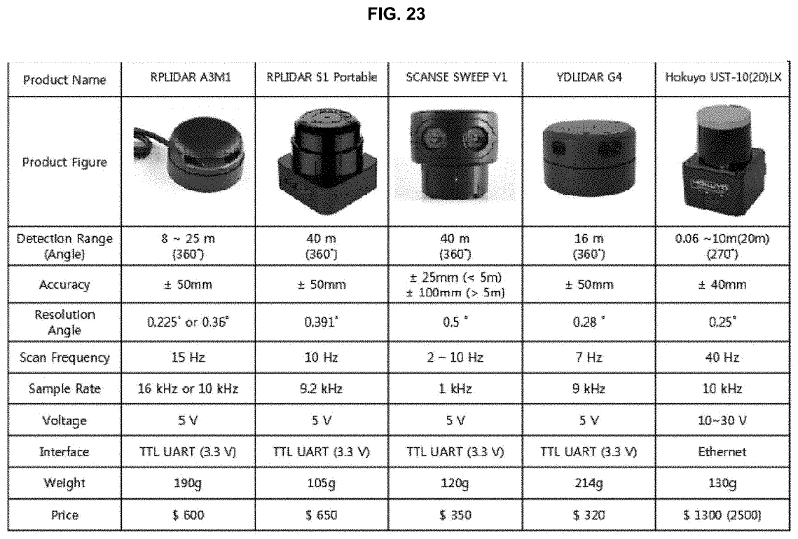

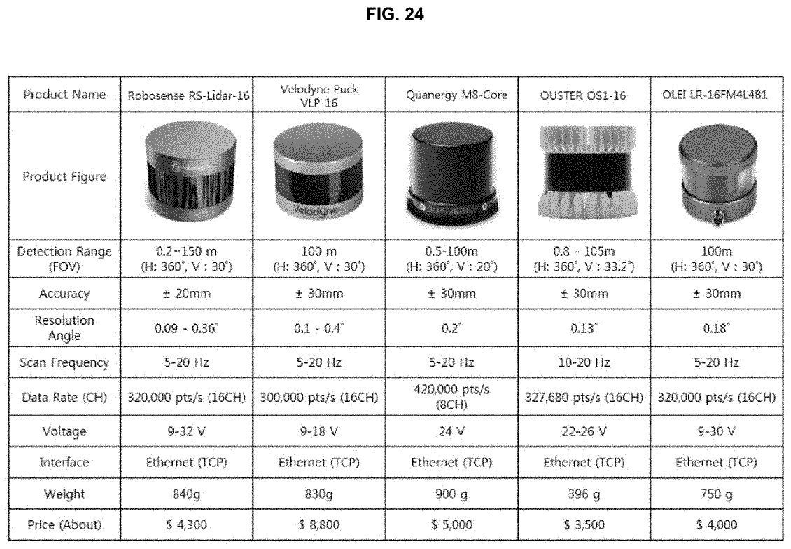

FIGS. 23 and 24 show examples of a lidar of the unmanned aerial robot according to the embodiment of the present disclosure. FIGS. 23 and 24 show examples of lidar sensors, FIG. 23 shows examples of a 2D lidar sensor, and FIG. 24 shows examples of a 3D lidar sensor. The 2D lidar sensors of FIG. 23 are smaller in size, simpler, and less expensive than the 3D lidar sensors of FIG. 24. However, it is more difficult for the 2D lidar sensors to obtain specific and precise information than the 3D lidar sensors. The 3D lidar sensors of FIG. 24 are larger in size, more complex, and more expensive than the 2D lidar sensors of FIG. 23, but may obtain specific and precise information than the 2D lidar sensors.

In the embodiment of the present disclosure, when the drone controls the attitude/position by using the plurality of beams generated from the station, a 2D lidar sensor may be used, and a 3D lidar sensor may be used to perform positioning on the measurement space. That is, in FIG. 12, a 2D lidar sensor may be used for the sensor 1115, and a 3D lidar sensor may be used for the positioning device 1113. When the 3D lidar sensor is used, the drone may additionally include additional computing power because the processing amount of information is increased.

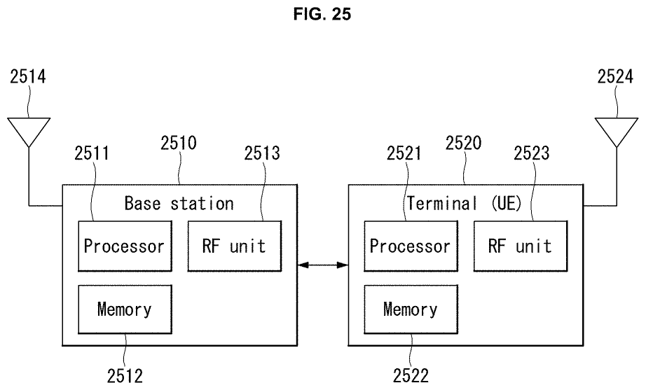

A general apparatus to which the present disclosure may be applied is now described. FIG. 25 illustrates a block diagram of a wireless communication device according to an embodiment of the present disclosure. Referring to FIG. 25, a wireless communication system includes a base station (or network) 2510 and a terminal 2520. In this case, the terminal may be a UE, a UAV, a drone, a radio aerial robot, etc.

The base station 2510 includes a processor 2511, a memory 2512, and a communication module 2513. The processor implements the functions, processes and/or methods proposed in FIGS. 1 to 19. The layers of a wired/wireless interface protocol may be implemented by the processor 2511. The memory 2512 is connected to the processor 2511 and stores various pieces of information for driving the processor 2511. The communication module 2513 is connected to the processor 2511 and transmits and/or receives wired/wireless signals.

The communication module 2513 may include a radio frequency (RF) unit for transmitting/receiving a radio signal. The terminal 2520 includes a processor 2521, a memory 2522, and a communication module (or RF unit) 2523. The processor 2521 implements the functions, processes and/or methods proposed in FIGS. 1 to 19. The layers of a radio interface protocol may be implemented by the processor 2521. The memory 2522 is connected to the processor 2521 and stores various pieces of information for driving the processor 2521. The communication module 2523 is connected to the processor 2521 and transmits and/or receives a radio signal.

The memories 2512 and 2522 may be positioned inside or outside the processors 2511 and 2521 and may be connected to the processors 2511 and 2521 by various well-known means. Furthermore, the base station 2510 and/or the terminal 2520 may have a single antenna or multiple antennas.

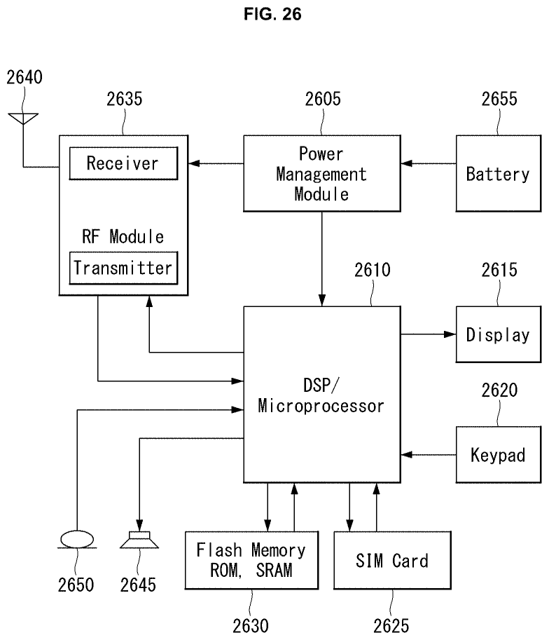

FIG. 26 illustrates a block diagram of a communication device according to an embodiment of the present disclosure. Particularly, FIG. 26 is a diagram illustrating more specifically the terminal of FIG. 25. Referring to FIG. 26, the terminal may include a processor (or digital signal processor (DSP)) 2610, an RF module (or RF unit) 2635, a power management module 2605, an antenna 2640, a battery 2655, a display 2615, a keypad 2620, a memory 2630, a subscriber identification module (SIM) card 2625 (this element is optional), a speaker 2645, and a microphone 2650. The terminal may further include a single antenna or multiple antennas.

The processor 2610 implements the function, process and/or method proposed in FIGS. 1 to 19. The layers of a radio interface protocol may be implemented by the processor 2610. The memory 2630 is connected to the processor 2610, and stores information related to the operation of the processor 2610. The memory 2630 may be positioned inside or outside the processor 2610 and may be connected to the processor 2610 by various well-known means.

A user inputs command information, such as a telephone number, by pressing (or touching) a button of the keypad 2620 or through voice activation using the microphone 2650, for example. The processor 2610 receives such command information and performs processing so that a proper function, such as making a phone call to the telephone number, is performed. Operational data may be extracted from the SIM card 2625 or the memory 2630. Furthermore, the processor 2610 may display command information or driving information on the display 2615 for user recognition or convenience.

The RF module 2635 is connected to the processor 2610 and transmits and/or receives RF signals. The processor 2610 delivers command information to the RF module 2635 so that the RF module 2635 transmits a radio signal that forms voice communication data, for example, in order to initiate communication. The RF module 2635 includes a receiver and a transmitter in order to receive and transmit radio signals. The antenna 2640 functions to transmit and receive radio signals. When a radio signal is received, the RF module 2635 delivers the radio signal so that it is processed by the processor 2610, and may convert the signal into a baseband. The processed signal may be converted into audible or readable information output through the speaker 2645.

The aforementioned embodiments have been achieved by combining the elements and characteristics of the present disclosure in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present disclosure. Order of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be materialized in other specific forms without departing from the essential characteristics of the present disclosure. Accordingly, the detailed description should not be construed as being limitative, but should be construed as being illustrative from all aspects. The scope of the present disclosure should be determined by reasonable analysis of the attached claims, and all changes within the equivalent range of the present disclosure are included in the scope of the present disclosure.

According to the present disclosure, by performing indoor positioning using the unmanned aerial robot, positioning on the space where direct positioning is difficult may be performed. In addition, according to the present disclosure, by using all the measurement results obtained through the camera and the sensor, indoor positioning may be accurately performed.

In addition, according to the present disclosure, since the unmanned aerial robot performs positioning on the space while increasing or decreasing the altitude only on the vertical axis at the specific position, positioning according to the altitude may be performed in the narrow space. In addition, according to the present disclosure, since the unmanned aerial robot performs positioning while flying vertically in a fixed state at the specific position by using the station and the horizontal axis position is not changed, accurate positioning may be performed. In addition, by providing absolute coordinates that may be controlled in real time to the unmanned aerial robot flying vertically in the narrow space, the lidar mapping error may be reduced.

Aspects of the present disclosure are not limited to the above-described features, and other technical aspects not described above may be evidently understood by those skilled in the art to which the present disclosure pertains from the following description.

An aspect of the present disclosure provides a method for charging a battery of an unmanned aerial robot in an unmanned aerial system. Further, another aspect of the present disclosure is to provide a method for performing indoor positioning by using an unmanned aerial robot. Further, still another aspect of the present disclosure is to provide a method for performing positioning while increasing or decreasing only an altitude of a drone on a vertical axis without horizontal movement, when indoor positioning is performed by using an unmanned aerial robot. Further, still another aspect of the present disclosure is to provide a method for increasing or decreasing an altitude of an unmanned aerial robot on a vertical axis while maintaining a horizontal axis position by using a station. Further, still another aspect of the present disclosure is to provide a method for performing indoor positioning by using a camera and/or a laser sensor while an unmanned aerial robot is vertically flying.

According to an aspect of the present disclosure, there is provided a flight system for indoor positioning. The system includes an unmanned aerial robot, a station of the unmanned aerial robot, and a server. The unmanned aerial robot senses a plurality of laser beams generated from the station through a first camera and/or a first sensor, performs adjustment such that a horizontal axis position of the unmanned aerial robot is located at a center position of a measurement space for the indoor positioning based on the plurality of sensed laser beams, and performs positioning on the measurement space while flying in a vertical direction. The station measures a distance to each wall surface of the measurement space by using a laser sensor to be located at the center position of the measurement space, moves to the center position based on the measured distance, performs adjustment such that the station is horizontal by using a horizontal sensor and a horizontal mechanical device, and generates the plurality of laser beams by using a plurality of laser beam generators such that the unmanned aerial robot performs positioning on the measurement space while flying vertically at the center position of the measurement space.

Further, in the present disclosure, the unmanned aerial robot may recognize a position where the plurality of laser beams is generated by using the first camera, and sense the plurality of laser beams by using the first sensor based on the recognized position to determine whether the unmanned aerial robot is located at the center position. Further, in the present disclosure, the unmanned aerial robot may recognize whether the unmanned aerial robot is located at the center position of the measurement space by using a result obtained by sensing the plurality laser beams through the first camera and/or the first sensor.

Further, in the present disclosure, the unmanned aerial robot may recognize that the unmanned aerial robot has moved from the center position of the measurement space when at least one of the plurality of laser beams is not sensed by the first camera or the first sensor, and move the position such that the plurality of laser beams is sensed by the first camera or the first sensor.

Further, in the present disclosure, the unmanned aerial robot may measure respective distances between the unmanned aerial robot and the station by using the plurality of laser beams, and recognize whether the unmanned aerial robot is horizontal with the station by using the respective measured distances.

Further, in the present disclosure, the unmanned aerial robot may recognize that the unmanned aerial robot is not horizontal with the station when the respective distances are different from each other, and adjust a vertical position and/or a horizontal position of the unmanned aerial robot such that the respective measured distances are equal to each other. Further, in the present disclosure, the unmanned aerial robot may photograph the measurement space by using a second camera to obtain an image for performing positioning on the measurement space.

Further, in the present disclosure, the unmanned aerial robot may generate a plurality of measurement beams through at least one three-dimensional (3D) light detection and ranging (lidar) sensor, sense a reflected beam obtained by reflecting the generated measurement beam by the measurement space through the at least one 3D lidar sensor to obtain modeling for the measurement space, and perform positioning on the measurement space by using the image and the modeling together.

Further, in the present disclosure, the unmanned aerial robot may transmit a result of the positioning to the server. Further, in the present disclosure, the unmanned aerial robot may receive, from the server, path information related to a flight path for performing positioning on the measurement space.

Further, in the present disclosure, the station may generate at least one laser beam by using the laser sensor, and sense a reflected beam obtained by reflecting the at least one laser beam by each wall surface of the measurement space to measure a distance to each wall surface.

Further, in the present disclosure, the station may charge a battery of the unmanned aerial robot by using a wireless charging module when the unmanned aerial robot is located within a predetermined distance. Further, in the present disclosure, the station may move to the center position of the measurement space based on the measured distance by using a horizontal moving device.

According to another aspect of the present disclosure, there is provided an unmanned aerial robot for indoor positioning. The robot includes a main body, a first camera and a second camera provided in the main body, a first sensor and a second sensor for sensing a laser beam, one or more motors, at least one propeller connected to each of the one or more motors, and a processor electrically connected to the one or more motors to control the one or more motors. The processor is configured to control the first camera and/or the first sensor to sense a plurality of laser beams generated from a station, perform adjustment such that a horizontal axis position of the unmanned aerial robot is located at a center position of a measurement space based on the at least one sensed laser beam, and control the at least one propeller to perform positioning on the measurement space while flying in a vertical direction.

In certain implementations, a system may comprise an unmanned aerial robot; and a station, wherein the unmanned aerial robot includes at least one of a first sensor or a first camera that senses a plurality of laser beams generated from the station, the unmanned aerial robot performing moving such that a horizontal axis position of the unmanned aerial robot is located at a center position of a measurement space for the indoor positioning based on sensing the plurality of laser beams, wherein the station includes: a laser sensor that measures respective distances from the station to wall surfaces of the measurement space based on detecting the laser beams, the station locating the center position of the measurement space and moving to the center position based on the measured distances, and an adjustable platform coupled to a plurality of laser beam generators to generate the plurality of laser beams, the adjustable platform including a horizontal sensor to determine a horizontal orientation for the adjustable platform, and one or more adjustment mechanisms to move the adjustable platform to the horizontal orientation, and wherein the unmanned aerial robot performs positioning in the measurement space while flying vertically at the center position of the measurement space.

The unmanned aerial robot recognize a position of the station where the plurality of laser beams are generated by using the first camera, and senses the plurality of laser beams by using the first sensor based on the recognized position to determine whether the unmanned aerial robot is located at the center position. The unmanned aerial robot may recognize whether the unmanned aerial robot is located at the center position of the measurement space based on sensing the plurality laser beams through one or more of the first camera or the first sensor.

The unmanned aerial robot may recognize that the unmanned aerial robot has moved from the center position of the measurement space when at least one of the plurality of laser beams is not sensed by the first camera or the first sensor, and the unmanned aerial robot moves to center position based on moving until each the plurality of laser beams is sensed by the first camera or the first sensor.

The unmanned aerial robot measures respective distances between the unmanned aerial robot and sections of the station by using the plurality of laser beams, and recognizes whether the unmanned aerial robot is horizontal with the station by using the respective measured distances between the unmanned aerial robot and the sections of the station. The unmanned aerial robot may recognize that the unmanned aerial robot is not horizontal with the station when the respective distances between the unmanned aerial robot and the sections of the station are different from each other, and adjusts at least one of a vertical position or a horizontal position of the unmanned aerial robot such that the respective measured distances between the unmanned aerial robot and the sections of the station correspond to each other.

The unmanned aerial robot may further include a second camera that photographs the measurement space to obtain an image for performing positioning in the measurement space. The unmanned aerial robot further includes at least one three-dimensional (3D) light detection and ranging (lidar) sensor that generates a plurality of measurement beams, and senses at least one reflected beam corresponding to at least one of the generated measurement beams reflected by the measurement space to model the measurement space, and wherein the unmanned aerial robot further performs positioning in the measurement space by using the image and the model of the measurement space.

The unmanned aerial robot may transmit a result of performing positioning to a server. The unmanned aerial robot may receive, from a server, path information related to a flight path for performing positioning in the measurement space.

The laser sensor may sense reflected beams obtained by reflecting at least one of the generated laser beams from each of the wall surface of the measurement space to measure a distance to each of the wall surfaces. The station may further include a wireless charging module that charges a battery of the unmanned aerial robot when the unmanned aerial robot is located within a particular distance of the station. The station may further include a wheel that rotates to move the station to the center position of the measurement space based on the measured distance.

In certain implementations, an unmanned aerial robot for indoor positioning, the unmanned aerial robot may comprise a main body; a first camera and a second camera provided in the main body; a first sensor and a second sensor that detect laser beams; one or more motors; at least one propeller connected to the one or more motors; and a processor to control the one or more motors, wherein the processor is further configured to: control at least one of the first camera or the first sensor to sense at least one of a plurality of laser beams generated from a station, perform adjustment such that a horizontal axis position of the unmanned aerial robot is located at a center position of a measurement space based on the sensed at least one of the plurality of laser beams, and control the at least one propeller to perform positioning in the measurement space while flying in a vertical direction.

The processor may be further configured to recognize a position of the station where the plurality of laser beams are generated by using the first camera, and sense the plurality of laser beams by using the first sensor based on the recognized position to determine whether the unmanned aerial robot is located at the center position. The processor may be further configured to recognize whether the unmanned aerial robot is located at the center position of the measurement space based on sensing the plurality laser beams through the at least one of the first camera or the first sensor.

The processor may be configured to recognize that the unmanned aerial robot has moved from the center position of the measurement space when at least one of the plurality of laser beams is not sensed by the first camera or the first sensor, and control the at least one propeller to change a position of the unmanned aerial robot such that each of the plurality of laser beams is sensed by the first camera or the first sensor.

The processor may be further configured to measure respective distances between the unmanned aerial robot and regions of the station based on sensing the plurality of laser beams, and recognize whether the unmanned aerial robot is horizontal with the station based on the respective measured distances between the unmanned aerial robot and the regions of the station.

The processor may be further configured to recognize that the unmanned aerial robot is not horizontal with the station when the respective distances between the unmanned aerial robot and the regions of the station are different from each other, and adjust at least one of a vertical position or a horizontal position of the unmanned aerial robot such that the respective measured distances are equal to each other.

The unmanned aerial robot may further comprise a 3D lidar sensor, and the processor may further configured to: control the second camera to photograph the measurement space to obtain an image for performing positioning in the measurement space, control the 3D lidar sensor to generate a plurality of measurement beams and to sense reflections of the measurement beams from the measurement space, model the measurement space based on the reflections, and perform positioning in the measurement space based on the image and the modelling of the measurement space.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A system comprising:
an unmanned aerial robot; and
a station,
wherein the unmanned aerial robot includes at least one of a first sensor or a first camera that senses a plurality of laser beams generated from the station, the unmanned aerial robot performing moving such that a horizontal axis position of the unmanned aerial robot is located at a center position of a measurement space for indoor positioning based on sensing the plurality of laser beams,
wherein the station includes:
a laser sensor that measures respective distances from the station to wall surfaces of the measurement space based on detecting the laser beams, the station locating the center position of the measurement space and moving to the center position based on the measured distances, and
an adjustable platform coupled to a plurality of laser beam generators to generate the plurality of laser beams, the adjustable platform including a horizontal sensor to determine a horizontal orientation for the adjustable platform, and one or more adjustment mechanisms to move the adjustable platform to the horizontal orientation, and
wherein the unmanned aerial robot performs positioning in the measurement space while flying vertically at the center position of the measurement space.

2. The system of claim 1, wherein the unmanned aerial robot recognizes a position of the station where the plurality of laser beams are generated by using the first camera, and senses the plurality of laser beams by using the first sensor based on the recognized position to determine whether the unmanned aerial robot is located at the center position.

3. The system of claim 2, wherein the unmanned aerial robot recognizes whether the unmanned aerial robot is located at the center position of the measurement space based on sensing the plurality laser beams through one or more of the first camera or the first sensor.

4. The system of claim 3, wherein the unmanned aerial robot recognizes that the unmanned aerial robot has moved from the center position of the measurement space when at least one of the plurality of laser beams is not sensed by the first camera or the first sensor, and the unmanned aerial robot moves to center position based on moving until each the plurality of laser beams is sensed by the first camera or the first sensor.

5. The system of claim 1, wherein the unmanned aerial robot measures respective distances between the unmanned aerial robot and sections of the station by using the plurality of laser beams, and recognizes whether the unmanned aerial robot is horizontal with the station by using the respective measured distances between the unmanned aerial robot and the sections of the station.

6. The system of claim 5, wherein the unmanned aerial robot recognizes that the unmanned aerial robot is not horizontal with the station when the respective distances between the unmanned aerial robot and the sections of the station are different from each other, and adjusts at least one of a vertical position or a horizontal position of the unmanned aerial robot such that the respective measured distances between the unmanned aerial robot and the sections of the station correspond to each other.

7. The system of claim 1, wherein the unmanned aerial robot further includes a second camera that photographs the measurement space to obtain an image for performing positioning in the measurement space.

8. The system of claim 7, wherein the unmanned aerial robot further includes at least one three-dimensional (3D) light detection and ranging (lidar) sensor that generates a plurality of measurement beams, and senses at least one reflected beam corresponding to at least one of the generated measurement beams reflected by the measurement space to model the measurement space, and
wherein the unmanned aerial robot further performs positioning in the measurement space by using the image and the modelling of the measurement space.

9. The system of claim 8, wherein the unmanned aerial robot transmits a result of performing positioning to a server.

10. The system of claim 1, wherein the unmanned aerial robot receives, from a server, path information related to a flight path for performing positioning in the measurement space.

11. The system of claim 1, wherein the laser sensor senses reflected beams obtained by reflecting at least one of the generated laser beams from each of the wall surface of the measurement space to measure a distance to each of the wall surfaces.

12. The system of claim 1, wherein the station further includes a wireless charging module that charges a battery of the unmanned aerial robot when the unmanned aerial robot is located within a particular distance of the station.

13. The system of claim 1, wherein the station further includes a wheel that rotates to move the station to the center position of the measurement space based on the measured distance.

14. An unmanned aerial robot for indoor positioning, the unmanned aerial robot comprising:
a main body;
a first camera and a second camera provided in the main body;
a first sensor and a second sensor that detect laser beams;
one or more motors;
at least one propeller connected to the one or more motors; and
a processor to control the one or more motors,
wherein the processor is further configured to:
control at least one of the first camera or the first sensor to sense at least one of a plurality of laser beams generated from a station,
perform adjustment such that a horizontal axis position of the unmanned aerial robot is located at a center position of a measurement space based on the sensed at least one of the plurality of laser beams, and
control the at least one propeller to perform positioning in the measurement space while flying in a vertical direction.

15. The unmanned aerial robot of claim 14, wherein the processor is further configured to recognize a position of the station where the plurality of laser beams are generated by using the first camera, and sense the plurality of laser beams by using the first sensor based on the recognized position to determine whether the unmanned aerial robot is located at the center position.

16. The unmanned aerial robot of claim 15, wherein the processor is further configured to recognize whether the unmanned aerial robot is located at the center position of the measurement space based on sensing the plurality laser beams through the at least one of the first camera or the first sensor.

17. The unmanned aerial robot of claim 16, wherein the processor is configured to:
recognize that the unmanned aerial robot has moved from the center position of the measurement space when at least one of the plurality of laser beams is not sensed by the first camera or the first sensor, and
control the at least one propeller to change a position of the unmanned aerial robot such that each of the plurality of laser beams is sensed by the first camera or the first sensor.

18. The unmanned aerial robot of claim 14, wherein the processor is configured to:
measure respective distances between the unmanned aerial robot and regions of the station based on sensing the plurality of laser beams, and
recognize whether the unmanned aerial robot is horizontal with the station based on the respective measured distances between the unmanned aerial robot and the regions of the station.

19. The unmanned aerial robot of claim 18, wherein the processor is further configured to:
recognize that the unmanned aerial robot is not horizontal with the station when the respective distances between the unmanned aerial robot and the regions of the station are different from each other, and
adjust at least one of a vertical position or a horizontal position of the unmanned aerial robot such that the respective measured distances are equal to each other.

20. The unmanned aerial robot of claim 15, wherein the unmanned aerial robot further comprises a three-dimensional (3D) light detection and ranging (lidar) sensor, and
wherein the processor is further configured to:
control the second camera to photograph the measurement space to obtain an image for performing positioning in the measurement space,
control the 3D lidar sensor to generate a plurality of measurement beams and to sense reflections of the measurement beams from the measurement space,
model the measurement space based on the reflections, and
perform positioning in the measurement space based on the image and the modelling of the measurement space.
